(19) United States
(12) Patent Application Publication
(10) Pub. No.: US 2026/0179283 A1
(43) Pub. Date: Jun. 25, 2026

(54) FACIAL IMAGE REPLACEMENT METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventors: Keke HE, Shenzhen (CN); Junwei ZHU, Shenzhen (CN); Ying TAI, Shenzhen (CN); Chengjie WANG, Shenzhen (CN)

(21) Appl. No.: 19/321,169

(22) Filed: Sep. 5, 2025

Related U.S. Application Data
(63) Continuation of application No. PCT/CN2024/107768, filed on Jul. 26, 2024.

(30) Foreign Application Priority Data
Aug. 3, 2023 (CN) 202310969507.7

(51) Int. Cl. G06T 11/60; G06V 10/82; G06V 40/16

(52) U.S. Cl. CPC G06T 11/60; G06V 10/82; G06V 40/168; G06V 40/172

(57) ABSTRACT

A facial image replacement includes: acquiring a first sample image, a second sample image, and a sample replacement image, the sample replacement image being an image obtained by replacing a first facial region in the first sample image with a second facial region in the second sample image; performing noise addition on the sample replacement image n times in a time dimension by using sample noise data; performing, in a process of performing facial region replacement on the first sample image and the second sample image by using a facial image replacement model, prediction based on the sample noise-added image to obtain predicted noise data for restoring the sample replacement image based on the sample noise-added image; and training the facial image replacement model by using a difference between the sample noise data and the predicted noise data, to obtain a trained facial image replacement model.

### RELATED APPLICATIONS

This application is a continuation application of PCT Patent Application No. PCT/CN2024/107768, filed on Jul. 26, 2024, which claims priority to Chinese Patent Application No. 202310969507.7, filed on Aug. 3, 2023, all of which is incorporated herein by reference in their entirety.

### FIELD OF THE TECHNOLOGY

Embodiments of the present disclosure relate to the field of computer technologies, and in particular, to a facial image replacement method and apparatus, a device, a storage medium, and a program product.

### BACKGROUND OF THE DISCLOSURE

Facial image replacement has a wide range of application scenarios, such as in film and television portrait production, game character design, and virtual avatar creation. Taking the film and television production scenario as an example, when an actor cannot complete a professional-level action, the action may be completed by a professional first, and the face of the professional is replaced later by using a facial image replacement process, allowing film and television production to be completed while ensuring safety of the actor.

In a general process, after a first image and a second image for facial image replacement are obtained, facial keypoint extraction is performed on both images, respectively. Multiple first facial keypoints corresponding to a facial region in the first image are identified, as well as multiple second facial keypoints corresponding to a facial region in the second image. Further, the facial region in the first image is replaced with the facial region in the second image according to an image registration result between the first image and the second image and a corresponding relationship between the first facial keypoints and the second facial keypoints, thereby implementing a facial replacement process.

However, in the foregoing method, image sharpness of the first image and the second image is not fully considered. When the image sharpness of the first image and the second image is relatively low, accuracy of extraction results of the first and second facial keypoints is also relatively low. Further, after the facial replacement process is implemented according to the corresponding relationship between the first and second facial keypoints, the quality of the resulting replaced facial image is poor, which significantly affects the facial replacement effect.

### SUMMARY

One embodiment of the present disclosure provides a facial image replacement method. The method includes: acquiring a first sample image, a second sample image, and a sample replacement image, the sample replacement image being an image obtained by replacing a first facial region in the first sample image with a second facial region in the second sample image; performing noise addition on the sample replacement image n times in a time dimension by using sample noise data, to obtain a sample noise-added image, n being a positive integer; performing, in a process of performing facial region replacement on the first sample image and the second sample image by using a facial image replacement model, prediction based on the sample noise-added image to obtain predicted noise data, the predicted noise data being configured for restoring the sample replacement image based on the sample noise-added image; and training the facial image replacement model by using a difference between the sample noise data and the predicted noise data, to obtain a trained facial image replacement model, the trained facial image replacement model being configured to replace a first facial region in a first image with a second facial region in a second image.

Another embodiment of the present disclosure provides a computer device. The computer device includes one or more processors and a memory containing at least one program that, when being executed causes the one or more processors to perform: acquiring a first sample image, a second sample image, and a sample replacement image, the sample replacement image being an image obtained by replacing a first facial region in the first sample image with a second facial region in the second sample image; performing noise addition on the sample replacement image n times in a time dimension by using sample noise data, to obtain a sample noise-added image, n being a positive integer; performing, in a process of performing facial region replacement on the first sample image and the second sample image by using a facial image replacement model, prediction based on the sample noise-added image to obtain predicted noise data, the predicted noise data being configured for restoring the sample replacement image based on the sample noise-added image; and training the facial image replacement model by using a difference between the sample noise data and the predicted noise data, to obtain a trained facial image replacement model, the trained facial image replacement model being configured to replace a first facial region in a first image with a second facial region in a second image.

Another embodiment of the present disclosure provides a non-transitory computer readable storage medium containing at least one program that, when being executed causes at least one processor to perform: acquiring a first sample image, a second sample image, and a sample replacement image, the sample replacement image being an image obtained by replacing a first facial region in the first sample image with a second facial region in the second sample image; performing noise addition on the sample replacement image n times in a time dimension by using sample noise data, to obtain a sample noise-added image, n being a positive integer; performing, in a process of performing facial region replacement on the first sample image and the second sample image by using a facial image replacement model, prediction based on the sample noise-added image to obtain predicted noise data, the predicted noise data being configured for restoring the sample replacement image based on the sample noise-added image; and training the facial image replacement model by using a difference between the sample noise data and the predicted noise data, to obtain a trained facial image replacement model, the trained facial image replacement model being configured to replace a first facial region in a first image with a second facial region in a second image.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show only some embodiments of the present disclosure, and a person of ordinary skill in the art may still derive other drawings from these accompanying drawings without creative efforts.

FIG. 1 is a schematic diagram of an implementation environment according to an exemplary embodiment of the present disclosure.

FIG. 2 is a flowchart of a facial image replacement method according to an exemplary embodiment of the present disclosure.

FIG. 3 is a flowchart of a facial image replacement method according to an exemplary embodiment of the present disclosure.

FIG. 4 is a schematic diagram of acquiring a sample replacement image according to an exemplary embodiment of the present disclosure.

FIG. 5 is a schematic diagram of noise-addition processing according to an exemplary embodiment of the present disclosure.

FIG. 6 is a schematic flowchart of acquiring predicted noise data according to an embodiment of the present disclosure.

FIG. 7 is a flowchart of a facial image replacement method according to an exemplary embodiment of the present disclosure.

FIG. 8 is a schematic structural diagram of a facial image replacement model according to an exemplary embodiment of the present disclosure.

FIG. 9 is a schematic diagram of an encoder network and a decoder network according to an exemplary embodiment of the present disclosure.

FIG. 10 is a flowchart of a facial image replacement method according to an exemplary embodiment of the present disclosure.

FIG. 11 is a schematic diagram of denoising according to an exemplary embodiment of the present disclosure.

FIG. 12 is a structural block diagram of a facial image replacement apparatus according to an exemplary embodiment of the present disclosure.

FIG. 13 is a structural block diagram of a facial image replacement apparatus according to an exemplary embodiment of the present disclosure.

FIG. 14 is a structural block diagram of a server according to an exemplary embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

Embodiments of the present disclosure provide a facial image replacement method and apparatus, a device, a storage medium, and a program product, which can remove noises and implement a facial replacement process at the same time, thereby preventing the problems of poor facial replacement effect caused by low image sharpness, and improving robustness of a trained facial image replacement model.

In the embodiments of the present disclosure, a sample replacement image representing reference information is acquired, and noise addition is performed on the sample replacement image n times in a time dimension by using sample noise data, to obtain a sample noise-added image. In a process of performing facial region replacement on a first sample image and a second sample image by using a facial image replacement model, predicted noise data corresponding to a facial region replacement process is predicted by using the sample noise-added image, and then the facial image replacement model is trained by using a difference between the sample noise data and the predicted noise data. A prediction process of performing noise distribution on the sample noise-added image by using the facial image replacement model helps to enable the facial image replacement model to learn a noise relationship between sample images (including the first sample image and the second sample image) and the sample noise-added image. By further incorporating reference replacement between the sample replacement image, and the first/second sample images, it is conducive to improving a process of analyzing noise by the facial image replacement model in a targeted manner. Further, an image with relatively low sharpness is adjusted in a targeted manner by using a noise prediction process, to remove noise and implement a facial replacement process, thereby preventing a problem of a relatively poor generation effect of facial replacement due to relatively low image sharpness and improving robustness of the trained facial image replacement model, which helps to apply the trained facial image replacement model to a wider range of facial replacement scenarios.

The information (including, but not limited to, user equipment information, user personal information, and the like), data (including, but not limited to, data for analysis, stored data, displayed data, and the like), and signals involved in the present disclosure are all authorized by a user or fully authorized by each party, and the collection, use, and processing of relevant data need to comply with relevant laws and regulations of relevant regions. For example, the first sample image, the second sample image, the sample replacement image, the facial image replacement model, the first image, the second image, and other content as referred to in the present disclosure are all acquired under full authorization.

An implementation environment as referred to in the embodiments of the present disclosure is described below. A facial image replacement method provided in the embodiments of the present disclosure may be performed by a terminal alone, by a server, or by a terminal and a server together through data interaction, which is not limited in the embodiments of the present disclosure. Descriptions are provided below by using an example in which a terminal and a server interact to perform the facial image replacement method.

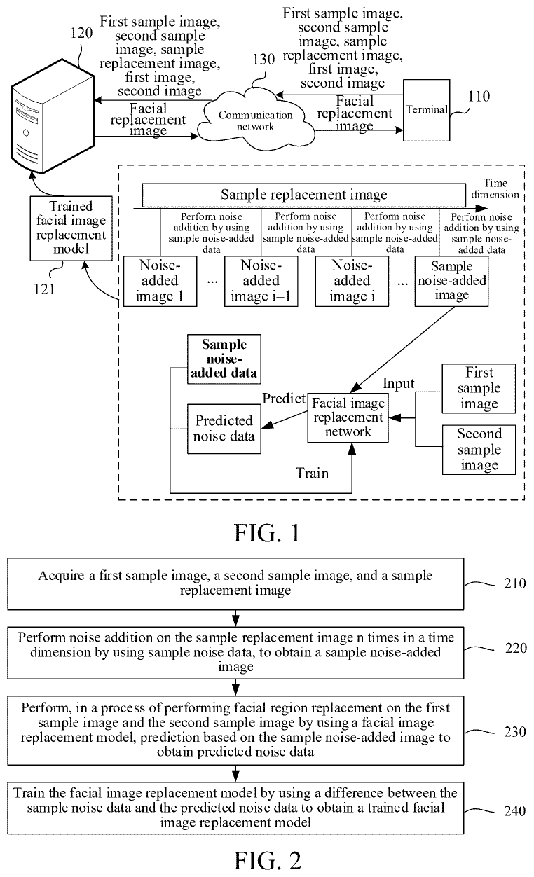

Referring to FIG. 1, the implementation environment includes a terminal 110 and a server 120. The terminal 110 is connected to the server 120 by using a communication network 130.

In some embodiments, the terminal 110 has an image acquisition function and is configured to obtain at least one of a first sample image, a second sample image, and a sample replacement image. The sample replacement image is an image obtained by replacing a first facial region in the first sample image with a second facial region in the second sample image (e.g., by swapping a second facial region in the second sample image with a first facial region in the first sample image). After acquiring the first sample image and the second sample image, the terminal 110 performs facial replacement on the first sample image and the second sample image by using a pre-trained facial image replacement model, to obtain the sample replacement image.

In this embodiment, after acquiring the first sample image, the second sample image, and the sample replacement image, the terminal 110 transmits the first sample image, the second sample image, and the sample replacement image to the server 120 by using the communication network 130, so that the server 120 obtains the first sample image, the second sample image, and the sample replacement image. Alternatively, after acquiring the first sample image and the second sample image, the terminal 110 transmits the first sample image and the second sample image to the server 120 by using the communication network 130. The server 120 performs facial replacement on the first sample image and the second sample image by using the pre-trained facial image replacement model, to obtain the sample replacement image, so that the server 120 obtains the first sample image, the second sample image, and the sample replacement image.

In some embodiments, the server 120 performs noise addition on the sample replacement image n times in a time dimension by using sample noise data, to obtain a sample noise-added image, where n is a positive integer.

In this embodiment, a facial image replacement model 121 is configured on the server 120. The facial image replacement model 121 is a to-be-trained model, and the facial image replacement model 121 is trained by using the first sample image, the second sample image, and the sample noise-added image that is obtained by performing noise addition on the sample replacement image n times.

In this embodiment, in the process of performing facial region replacement on the first sample image and the second sample image by using the facial image replacement model 121, prediction is performed based on the sample noise-added image to obtain predicted noise data. In addition, the server 120 trains the facial image replacement model 121 according to a difference between the sample noise data and the predicted noise data, to obtain the trained facial image replacement model 121. The trained facial image replacement model 121 is configured to swap a second image with a facial region in a first image. The foregoing process is an example of a non-exclusive case of a training process of the facial image replacement model 121.

In some embodiments, the terminal 110 transmits the first image and the second image, on which facial replacement needs to be performed, to the server 120 by using the communication network, and the server 120 performs a facial replacement process on the first image and the second image by using the trained facial image replacement model 121 and generates a facial replacement image after facial replacement. The facial replacement image can exclude, to a larger extent, a problem of noise interference that may exist in the facial replacement process, and even when both the first image and the second image have relatively low sharpness, a facial replacement image with relatively high image quality can be generated. In this embodiment, the server 120 may transmit the generated facial replacement image to the terminal 110 by using the communication network 130, so that the terminal 110 can render and display the facial replacement image on a screen of the terminal 110.

In this embodiment, the terminal includes, but is not limited to, mobile terminals such as a mobile phone, a tablet computer, a portable laptop computer, a smart voice interaction device, a smart home appliance, and a vehicle-mounted terminal, and may alternatively be implemented as a desktop computer or the like. The foregoing server may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

A cloud technology is a hosting technology that unifies a series of resources such as hardware, applications, and a network in a wide area network or a local area network, to implement data computing, storage, processing, and sharing. The cloud technology, a general term for a network technology, an information technology, an integration technology, a management platform technology, and an application technology that are applied based on a business mode of cloud computing, can form a resource pool and can be used on demand, which is flexible and convenient.

In some embodiments, the foregoing server may be further implemented as a node in a blockchain system.

With reference to the brief introduction to the terms and the application scenarios, the facial image replacement method provided in the present disclosure is described by using an example in which the method is applied to a server. As shown in FIG. 2, the method includes the following operation 210 to operation 240.

Operation 210: Acquire a first sample image, a second sample image, and a sample replacement image.

In this embodiment, the first sample image and the second sample image are images including facial regions.

In this embodiment, the first sample image and the second sample image are images pre-stored in an image library; or the first sample image and the second sample image are images captured by using an image capturing device; or the first sample image and the second sample image are images randomly acquired from a network.

In this embodiment, the first sample image and the second sample image may alternatively be image frames in a video work. For example, the first sample image and the second sample image may be image frames pre-selected or randomly selected from a video work such as a film and television work, a variety show work, or an animation work.

In this embodiment, the sample replacement image is an image obtained by replacing a first facial region in the first sample image with a second facial region in the second sample image (e.g., by swapping a second facial region in the second sample image with a first facial region in the first sample image).

In this embodiment, the facial region included in the first sample image is referred to as the first facial region, and the facial region included in the second sample image is referred to as the second facial region. A facial region is configured for representing a region occupied by a facial, and is configured for referring to a region in which facial replacement is performed.

In this embodiment, the first sample image is an image configured to be replaced with the second sample image. Therefore, the first sample image may be referred to as a source image, and the second sample image may be referred to as a target image.

In some embodiments, the sample replacement image is an image acquired by using a pre-trained facial image replacement model.

In this embodiment, the pre-trained facial image replacement model is acquired. The model is obtained by training a large quantity of sample images, has a facial replacement function, and can perform a facial replacement process with relatively high accuracy based on two sample images. In the process of training the facial image replacement model provided in this embodiment of the present disclosure, the first sample image and the second sample image are inputted to the to-be-trained model, to obtain a sample replacement image corresponding to the first sample image and the second sample image. The sample replacement image is taken as a reference image, to train the to-be-trained model based on the sample replacement image.

In this embodiment, the sample replacement image is annotated with a sample label, and the sample label may be at least one of a true label and a pseudo label.

In this embodiment, if a sample replacement image obtained by using a pre-trained model is taken as the reference image, a sample label with which the sample replacement image is annotated is a pseudo label. After the sample replacement image is obtained by using the pre-trained model, accuracy analysis and sample label annotation are manually performed on the sample replacement image, and the sample replacement image whose accuracy meets a preset requirement is taken as the reference image, so the sample label is a true label.

In this embodiment, a plurality of sample images are acquired. If any one of the plurality of sample images is taken as the first sample image, any sample image other than the first sample image in the plurality of sample images may be taken as the second sample image, and then a sample replacement image after facial replacement is acquired based on the first sample image and the second sample image. That is, the sample replacement image has a facial replacement relationship with the first sample image and the second sample image.

In this embodiment of the present disclosure, the plurality of sample images acquired include a sample image A, a sample image B, and a sample image C. If the sample image A is taken as the first sample image, either of the sample image B and the sample image C may be taken as the second sample image for facial replacement with the first sample image. For example, if facial replacement is performed on the sample image A and the sample image B, the second sample image is the sample image B, and facial replacement is performed based on the sample image A and the sample image B to obtain a sample replacement image 1. The sample replacement image 1 has a facial replacement relationship with the sample image A and the sample image B. Similarly, if facial replacement is performed on the sample image A and the sample image C, the second sample image is the sample image C, and facial replacement is performed based on the sample image A and the sample image C to obtain a sample replacement image 2. The sample replacement image 2 has a facial replacement relationship with the sample image A and the sample image C.

Similarly, if the sample image B is taken as the first sample image, either of the sample image A and the sample image C may be taken as the second sample image for facial replacement with the first sample image. Based on the foregoing process, a sample replacement image 3 having a facial replacement relationship with the sample image B and the sample image A may be further acquired, and/or a sample replacement image 4 having a facial replacement relationship with the sample image B and the sample image C may be further acquired.

Using the sample image A and the sample image B as an example, the sample image A may be taken as the first sample image and the sample image B may be taken as the second sample image, or the sample image B may be taken as the first sample image and the sample image A may be taken as the second sample image. Such different selections may affect a facial replacement direction, and two sample replacement images generated accordingly may also be different. For example, when the sample image A is the first sample image and the sample image B is the second sample image, the sample image B is used to replace the sample image A. When the sample image B is the first sample image and the sample image A is the second sample image, the sample image A is used to replace the sample image B. Therefore, facial replacement relationships respectively represented by the sample replacement image 1 and the sample replacement image 3 are different.

The foregoing is merely an illustrative example. The first sample image, the second sample image, and the sample replacement image are all images acquired with full authorization, which is not limited in this embodiment of the present disclosure.

Operation 220: Perform noise addition on the sample replacement image n times in a time dimension by using sample noise data, to obtain a sample noise-added image.

In this embodiment, after the sample replacement image is acquired, noise addition is performed on the sample replacement image n times in the time dimension by using the sample noise data, and an image obtained after n^{th} noise addition is referred to as the sample noise-added image.

In this embodiment, the sample noise data is preselected noise data.

In some embodiments, the sample noise data is implemented as fixed noise values. When noise addition is performed on the sample replacement image n times in the time dimension by using the sample noise data, a value of the sample noise data used during each noise addition is fixed, that is, a noise difference between any two adjacent noise-added images is sample noise data with a fixed value.

In some embodiments, the sample noise data is implemented as noise values with a certain change rule. When noise addition is performed on the sample replacement image n times in the time dimension by using the sample noise data, a value of the sample noise data used during each noise addition is determined according to a preset change rule, that is, a noise difference between any two adjacent noise-added images is a value determined based on the preset change rule, which may be the same or different. For example, the preset change rule may represent that in 10 noise addition processes, sample noise data used in the first 5 noise addition processes is a first noise value, and sample noise data used in the last 5 noise addition processes is a second noise value different from the first noise value.

In some embodiments, noise addition is performed on a sample replacement image at each of n moments represented by time-series distribution by using the sample noise data, so that each moment corresponds to a noise-added image. The noise-added image is image content determined based on moments (time-series information) and the sample noise data.

In this embodiment, two adjacent noise-added images are noise-added images respectively corresponding to two adjacent moments. Therefore, the two adjacent noise-added images are adjacent in the time dimension. For example, a moment t5 and a moment t6 are adjacent to each other in the time dimension, and a noise-added image that is in the n noise-added images and corresponds to the moment t5 is a noise-added image P5, and a noise-added image that is in the n noise-added images and corresponds to the moment t6 is a noise-added image P6. Then, the noise-added image P5 and the noise-added image P6 are two adjacent noise-added images in the time dimension.

In some embodiments, when noise addition is performed on the sample replacement image n times in the time dimension, noise-addition processing is performed on the sample replacement image in an iterative noise addition manner of n iterations. For example, noise-addition processing is performed on the sample replacement image at a moment t1, to obtain a noise-added image P1, then noise-addition processing is performed on the noise-added image P1 at a moment t2, to obtain a noise-added image P2, and so on. Therefore, after n iterations, an n^{th} noise-added image obtained after an n^{th} iteration of noise addition is taken as the sample noise-added image.

In some embodiments, when noise addition is performed on the sample replacement image n times in the time dimension, n moments are selected according to time-series distribution in the time dimension, and noise-addition processing is performed on the sample replacement image by using a preset noise-addition policy at the n moments. The preset noise-addition policy is a policy determined based on a moment parameter related to a moment and a noise parameter related to the sample noise data. For example, n moments are selected, and noise-addition processing is performed on the sample replacement image by using the preset noise-addition policy at a moment t1, to obtain the noise-added image P1. Then, noise-addition processing is performed on the sample replacement image by using the preset noise-addition policy at a moment t2, to obtain the noise-added image P2. Based on the moment parameter in the preset noise-addition policy, the noise-added image P1 and the noise-added image P2 that correspond to different moments t1 and t2 and are obtained after noise-addition processing are different. The sample noise-added image is a noise-added image obtained after noise-addition processing is performed on the sample replacement image by using the preset noise-addition policy at a moment tn. Since the preset noise-addition policy is related to the moment tn and the sample noise data, the sample noise-added image has an association relationship with the moment tn and the sample noise data.

In this embodiment, in the n noise-added images distributed in time series, noise intensity is positively correlated with the time-series distribution. For example, the time-series distribution is a moment t1, a moment t2, and the like. Noise intensity of the noise-added image P2 corresponding to the moment t2 is higher than noise intensity of the noise-added image P1 corresponding to the moment t1, and a sample noise-added image corresponding to the moment tn has the highest noise intensity.

In some embodiments, the noise-addition processing is implemented by adding noise. In this embodiment, the noise is implemented as Gaussian noise. The noise-addition processing process is implemented by adding the Gaussian noise. Intensity of the Gaussian noise is adjusted by changing a parameter that affects the Gaussian noise. The parameter includes at least one of a mean value, a standard deviation, noise intensity, and a smoothness level.

Operation 230: Perform, in a process of performing facial region replacement on the first sample image and the second sample image by using the facial image replacement model, prediction based on the sample noise-added image to obtain predicted noise data.

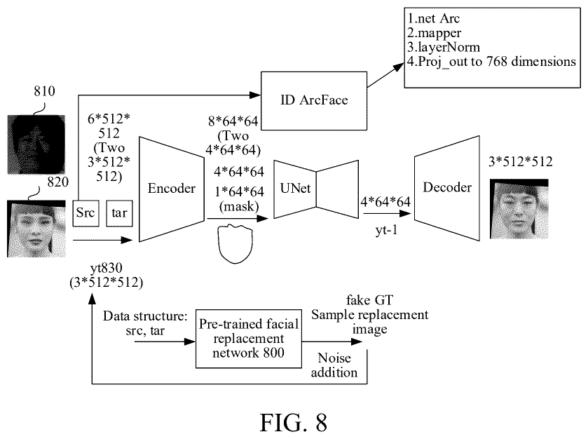

In this embodiment, the facial image replacement model is a neural network model, and is a model structure obtained after a stable diffusion model is improved. A convolutional network for biological medical image segmentation (UNet) used in the stable diffusion model is retained in the facial image replacement model, to implement, by using the UNet, a reverse denoising process represented by the stable diffusion model. A specific structure of the facial image replacement model is described below, referring to FIG. 8.

In this embodiment, n moments are selected based on the time-series distribution, each moment corresponds to a noise-added image, and each noise-added image may be referred to as a noise-added image after the noise-adding operation.

In some embodiments, a noise-added image obtained after n^{th} noise addition is used for a model training process, that is, model training is performed on the facial image replacement model by using a sample noise-added image obtained after the n^{th} noise addition.

The facial image replacement model is a to-be-trained model, and is configured to perform a facial replacement process between the first sample image and the second sample image during model training.

In this embodiment, in the process of performing facial region replacement on the first sample image and the second sample image by using the facial image replacement model, prediction is performed based on the sample noise-added image to obtain the predicted noise data.

The predicted noise data is configured for obtaining the sample replacement image by restoration based on the sample noise-added image. In this embodiment, the predicted noise data is configured for denoising the sample noise-added image, to obtain the sample replacement image by restoration by using the first sample image and the second sample image as much as possible.

In this embodiment, in the process of performing facial region replacement on the first sample image and the second sample image by using the facial image replacement model, a denoised noise value when the sample noise-added image is denoised at least once is predicted, and the denoised noise value is taken as the predicted noise data.

In some embodiments, in the process of performing facial region replacement on the first sample image and the second sample image n times by using the facial image replacement model, prediction is performed based on the sample noise-added image to obtain n pieces of predicted noise data.

In this embodiment, the predicted noise data is configured for representing a prediction result corresponding to each restoration process when the sample noise-added image is gradually restored to the sample replacement image. The predicted noise data is configured for performing iterative denoising on the sample noise-added image multiple times, to reduce noise on the sample noise-added image as much as possible by using the first sample image and the second sample image as much as possible and obtain the sample replacement image by restoration.

For example, the n pieces of predicted noise data are prediction results obtained after prediction on noise added during the n^{th} noise addition, and each piece of predicted noise data is a prediction result obtained after prediction on noise added during the noise addition corresponding thereto.

Based on this, there is a corresponding relationship between at least one piece of predicted noise data and the sample noise data. Therefore, the facial image replacement model can be trained based on the predicted noise data and the sample noise data.

In this embodiment, the facial image replacement model is trained by using n noise-added images, the facial image replacement model is trained once by using each noise-added image, and iterative training is performed n times on the facial image replacement model by using n noise-added images having a time-series distribution relationship, to implement a process of performing iterative training n times on the facial image replacement model under one sample replacement image.

In this embodiment, taking a process of perform i^{th} training on the facial image replacement model by using an i^{th} noise-added image as an example, since training the facial image replacement model is to perform facial region replacement on the first sample image and the second sample image, the i^{th} training process for the facial image replacement model is a process of performing facial region replacement on the first sample image and the second sample image by using the facial image replacement model. That is, in a process of performing i^{th} facial region replacement on the first sample image and the second sample image by using the facial image replacement model, the first sample image, the second sample image, and the i^{th} noise-added image are taken as input to the facial image replacement model, and predicted noise data corresponding to the i^{th} facial region replacement process in which the i^{th} noise-added image participates in model training is determined based on the first sample image, the second sample image, and the i^{th} noise-added image.

In this embodiment, when a sample noise-added image is known, an objective of learning of the facial image replacement model is: to learn how much noise on the sample noise-added image is reduced so that a noise-reduced image can have a more accurate image replacement relationship with the first sample image and the second sample image, so as to obtain the sample replacement image by restoration.

In this embodiment, the image replacement relationship is configured for representing a replacement condition followed when the facial replacement image is acquired by using the first sample image and the second sample image. The image replacement relationship includes at least one of a plurality of image information replacement relationships such as a facial keypoint replacement relationship, a background replacement relationship, and an expression replacement relationship.

In this embodiment, the facial keypoint replacement relationship between the first sample image and the second sample image is implemented as that in a to-be-obtained facial replacement image, a second facial region in the second sample image needs to be used to replace facial keypoints corresponding to a first facial region in the first sample image.

The background replacement relationship is implemented as that in the to-be-obtained facial replacement image, an image background of the first sample image is not displayed, and an image background of the second sample image is retained.

The expression replacement relationship is implemented as that in the to-be-obtained facial replacement image, a facial expression of the second facial region in the second sample image is retained. For example, a facial expression of the first facial region in the first sample image is calm, and the facial expression of the second facial region in the second sample image is laughing, and the expression replacement relationship indicates that a facial expression of the facial replacement image is laughing.

In some embodiments, based on the image replacement relationship represented by the first sample image and the second sample image, the facial image replacement model performs prediction based on the sample noise-added image to obtain predicted noise data, and the predicted noise data is configured for obtaining a sample replacement image by prediction.

In this embodiment, n facial region replacement processes are performed on the first sample image and the second sample image by using the facial image replacement model, and prediction is performed based on the sample noise-added image to obtain predicted noise data respectively corresponding to the n facial region replacement processes.

In this embodiment, n pieces of predicted noise data are obtained by prediction by using the sample noise-added image, and each piece of predicted noise data is configured for obtaining a noise-added image by restoration before noise-addition processing, so that a sample replacement image is obtained by prediction by using the n pieces of predicted noise data. For example, after 3 noise addition processes are performed on the sample replacement image, a noise-added image 1, a noise-added image 2, and a sample noise-added image (noise-added image 3) are obtained. 3 pieces of predicted noise data are obtained by prediction by using the sample noise-added image, respectively representing predicting predicted noise data obtained during restoration from the sample noise-added image to the noise-added image 2, representing predicting predicted noise data obtained during restoration from the noise-added image 2 to the noise-added image 1, representing predicting predicted noise data obtained during restoration from the noise-added image 1 to the sample replacement image, and the like.

In this embodiment, the UNet configured for noise prediction in the stable diffusion model is retained in the facial image replacement model. When prediction is performed based on the sample noise-added image to obtain the predicted noise data, a noise prediction process is performed by using the UNet in the facial image replacement model according to the image replacement relationship represented by the first sample image and the second sample image, to obtain the predicted noise data.

In this embodiment, the facial image replacement model can denoise the sample noise-added image at least once based on the predicted noise data and the sample noise-added image, to obtain the predicted noise data by prediction.

In some embodiments, the predicted noise data is implemented as a predicted noise map. Noise is generally represented on an image as isolated pixels or pixel blocks that cause a relatively strong visual effect. Therefore, when noise on a sample noise-added image is described, noise situations respectively corresponding to different pixel positions when the sample noise-added image is analyzed may be represented by using a predicted noise map. For example, an image dimension of the predicted noise map is the same as an image dimension of the sample noise-added image.

In this embodiment, in an example in which the predicted noise data is a predicted noise map, since the predicted noise data is obtained after the sample noise-added image is analyzed under a condition of the image replacement relationship represented by the first sample image and the second sample image, noise values corresponding to different pixel positions in the predicted noise map may be different based on information represented by the image replacement relationship.

For example, in the facial keypoint replacement relationship in the image replacement relationship, it indicates that a pixel 1 in the sample noise-added image is implemented as information a at a nose in the first sample image, and a noise value of a pixel 1′ corresponding to the pixel 1 in the predicted noise map is determined based on the information a. The noise value indicates that: if the noise value is removed at the pixel 1 in the sample noise-added image, an image that is more conducive to clearly displaying the information a at the nose may be obtained.

In this embodiment, based on the foregoing process, noise values respectively corresponding to a plurality of pixels are determined by using the image replacement relationship, so as to obtain the predicted noise map. A plurality of pixels in the predicted noise map is in one-to-one correspondence to a plurality of pixels in the sample noise-added image, and noise values respectively corresponding to the plurality of pixels in the predicted noise map are values determined based on the image replacement relationship, so as to implement a facial replacement process more precisely when predicted noise is used.

The foregoing is merely an illustrative example. This is not limited in the embodiments of the present disclosure.

Operation 240: Train the facial image replacement model by using a difference between the sample noise data and the predicted noise data, to obtain a trained facial image replacement model.

In this embodiment, after the sample noise data and the predicted noise data are obtained, the difference between the sample noise data and the predicted noise data is determined, to obtain a noise loss value.

In this embodiment, the sample noise data is implemented as a sample noise map, and the predicted noise data is implemented as a predicted noise map. Since both the sample noise map and the predicted noise map are obtained based on the sample noise-added image, a plurality of pixels in the sample noise map is in one-to-one correspondence to a plurality of pixels in the predicted noise map. Pixel value differences respectively corresponding to the pixels are determined based on the corresponding relationship between the pixels, so as to obtain a noise loss value between the sample noise data and the predicted noise data based on the pixel value differences respectively corresponding to the plurality of pixels.

In this embodiment, the facial image replacement model is trained by using the noise loss value until the trained facial image replacement model is obtained.

In some embodiments, a model parameter of the facial image replacement model is adjusted based on the noise loss value, to obtain an intermediate model. The trained facial image replacement model is obtained in response to that training of the intermediate model based on the noise loss value reaches a training objective.

In this embodiment, the model parameter of the facial image replacement model is adjusted with an objective of reducing the noise loss value. For example, the noise loss value is reduced by using gradient descent. Alternatively, the noise loss value is reduced by using a back propagation algorithm.

In this embodiment, during the training of the intermediate model by using the noise loss value, the trained facial image replacement model is obtained after the training of the intermediate model reaches the training objective.

In this embodiment, in response to that the noise loss value reaches a convergence state, an intermediate model obtained by the most recent iterative training is taken as the trained facial image replacement model.

In this embodiment, the noise loss value reaching a convergence state is configured for indicating that a value of the noise loss value obtained by using a loss function no longer changes or variation magnitude is less than a preset threshold.

The trained facial image replacement model is configured to swap a second image with a facial region in a first image.

In this embodiment, after the trained facial image replacement model is obtained, the first image and the second image for facial replacement are inputted into the trained facial image replacement model, so as to perform a facial replacement process by using the first image and the second image.

The trained facial image replacement model is configured to perform, during denoising, the facial replacement process by using the image replacement relationship between the first image and the second image. Therefore, in addition to inputting the first image and the second image to the trained facial image replacement model, random noise data is further inputted into the trained facial image replacement model, so that the trained facial image replacement model denoises the random noise data multiple times by using the image replacement relationship between the first image and the second image, to swap the second image with the facial region in the first image.

In this embodiment, an image obtained after the second image is used to replace the facial region in the first image is referred to as a facial replacement image. The facial replacement image is an image obtained after the random noise data is denoised by using the image replacement relationship between the first image and the second image, which can prevent noise interference during the facial replacement between the first image and the second image and can also focus on more essential information (information represented by the image replacement relationship) when the first image and the second image have relatively low sharpness, so that the facial replacement image has relatively strong stability.

The foregoing is merely an illustrative example. This is not limited in the embodiments of the present disclosure.

In summary, a prediction process of performing noise distribution on the sample noise-added image by using the facial image replacement model helps to enable the facial image replacement model to learn a noise relationship between sample images and the sample noise-added image. By further incorporating reference replacement between the sample replacement image, and the first/second sample images, it is conducive to improving a process of analyzing noise by the facial image replacement model in a targeted manner. Further, an image with relatively low sharpness is adjusted in a targeted manner by using a noise prediction process, to remove noise and implement a facial replacement process, thereby preventing a problem of a relatively poor generation effect of facial replacement due to relatively low image sharpness and improving robustness of the trained facial image replacement model, which helps to apply the trained facial image replacement model to a wider range of facial replacement scenarios.

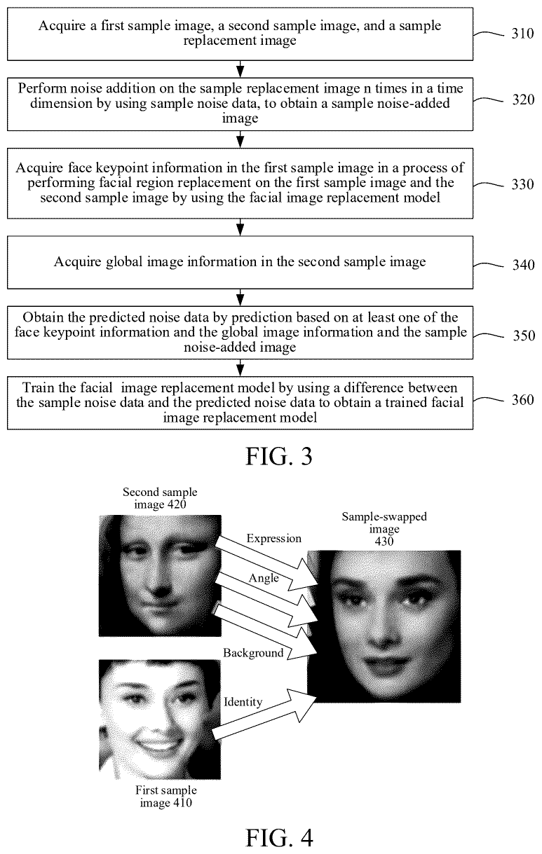

In this embodiment, in the process of performing facial region replacement on the first sample image and the second sample image by using the facial image replacement model, the predicted noise data is acquired by using at least one type of information represented by the first sample image and the second sample image. As shown in FIG. 3, the embodiment shown in FIG. 2 may alternatively be implemented as the following operation 310 to operation 360. Operation 230 may alternatively be implemented as the following operation 330 to operation 350.

Operation 310: Acquire a first sample image, a second sample image, and a sample replacement image.

In this embodiment, the first sample image and the second sample image are images including facial regions.

The sample replacement image is an image obtained by replacing a first facial region in the first sample image with a second facial region in the second sample image (e.g., by swapping a second facial region in the second sample image with a first facial region in the first sample image).

In some embodiments, before the first sample image and the second sample image are acquired, the two images including facial regions are acquired. Considering that a facial region in an image generally occupies a relatively small position, after the image is acquired, facial detection is first performed on the image, to obtain the facial region. Then, facial registration is performed in the facial region to obtain keypoints of a facial, including at least keypoints of eyes and mouth corners. In addition, cropped facial images are obtained according to the facial keypoints, and are taken as the first sample image and the second sample image. That is, after the images are preprocessed, facial images with clearer facial regions are obtained and are taken as the first sample image and the second sample image.

In this embodiment, the first sample image and the second sample image that are configured for generating the sample replacement image are determined based on the facial replacement relationship among the first sample image, the second sample image, and the sample replacement image, and the first sample image, the second sample image, and the sample replacement image are combined into a triplet. When there are a plurality of sample images, a plurality of triplets may be obtained based on this process.

In this embodiment, if it is determined that the first sample image and the second sample image that are configured for generating the sample replacement image 1 are the sample image A and the sample image B, a formed triplet may be represented as “sample image A-sample image B-sample replacement image 1”.

FIG. 4 is a schematic diagram of acquiring a sample replacement image by using a first sample image 410 and a second sample image 420. Based on a guarantee of an identity represented by the first sample image 410, an expression, an angle, and a background represented by the second sample image 420 are analyzed, so that when the second sample image 420 is used to replace the first sample image 410, the identity of the first sample image is maintained, and the second sample image 420 is used to replace information such as facial features represented by a facial in the first sample image 410, to obtain a sample replacement image 430.

Operation 320: Perform noise addition on the sample replacement image n times in a time dimension by using sample noise data, to obtain a sample noise-added image.

n is a positive integer.

In this embodiment, n iterations of noise addition are performed on the sample replacement image in the time dimension by using sample noise data with a same noise value, to obtain n noise-added images, where an n^{th} noise-added image is the sample noise-added image.

A noise difference between two adjacent noise-added images in the n noise-added images is the sample noise data.

In this embodiment, in a process of performing n iterations of noise addition on the sample replacement image in the time dimension, noise-addition processing is first performed on the sample replacement image, and then noise-addition processing is performed on the noise-added sample replacement image. For example, in a first noise addition process (for example, implemented as a moment t1 representing time-series information), noise-addition processing is performed on the sample replacement image, to obtain the noise-added image P1. In a second noise addition process (for example, implemented as a moment t2 representing time-series information), noise-addition processing is performed on the noise-added image P1, to obtain the noise-added image P2, so as to obtain sample noise-added images after n iterations of noise addition. The n noise-added images are distributed in time series.

In this embodiment, n iterations of noise addition are performed on the sample replacement image in the time dimension by using sample noise data with different noise values, to obtain the n noise-added images distributed in time series, where an n^{th} noise-added image is the sample noise-added image.

A noise difference between a v^{th} noise-added image and a v+1^{th} noise-added image is the sample noise data used during a v^{th} iteration of noise addition, and v is a positive integer no greater than n.

In this embodiment, n moments are selected in the time dimension according to time-series distribution. At the n moments, noise-addition processing is performed on the sample replacement image by using a preset noise-addition policy, to obtain n noise-added images distributed in time series, where an n^{th} noise-added image is the sample noise-added image.

In this embodiment, n moments are selected in the time dimension according to time-series distribution, the n moments are different from each other, and different moments represent different pieces of time-series information.

In this embodiment, the preset noise-addition policy is implemented as a preset noise-addition formula, the noise-addition formula includes a moment parameter representing time-series information, and moment parameters corresponding to different moments have different values. When noise-addition processing is performed on the sample replacement image by using the n moments and the preset noise-addition policy, due to differences between the n moments, noise-added images obtained after noise-addition processing is performed on the sample replacement image based on the noise-addition formula are also different.

In this embodiment, a noise parameter representing the sample noise data further exists in the preset noise-addition policy (noise-addition formula). The noise parameter is implemented as noise intensity. Sample noise data between two adjacent moments is determined based on a preset noise change rule, which may be the same or different. In this embodiment, when noise-addition processing is performed on the sample replacement image n times by using the noise-addition formula, a value of a noise parameter representing noise intensity remains unchanged in each noise-addition processing process. Alternatively, when noise-addition processing is performed on the sample replacement image n times by using the noise-addition formula, the value of the noise parameter representing noise intensity may change in different noise-addition processing processes.

In this embodiment, the noise-addition formula is implemented as the following formula (1).

$$y t = α ty 0 + ( 1 - α t ) ε \qquad ( 1 )$$

where yt is configured for representing a sample noise-added image obtained after noise-addition processing at a moment t; at is configured for representing time-series information corresponding to the moment t; y0 is configured for representing a sample replacement image; ¿ is configured for representing a noise parameter (for example, noise intensity of Gaussian noise).

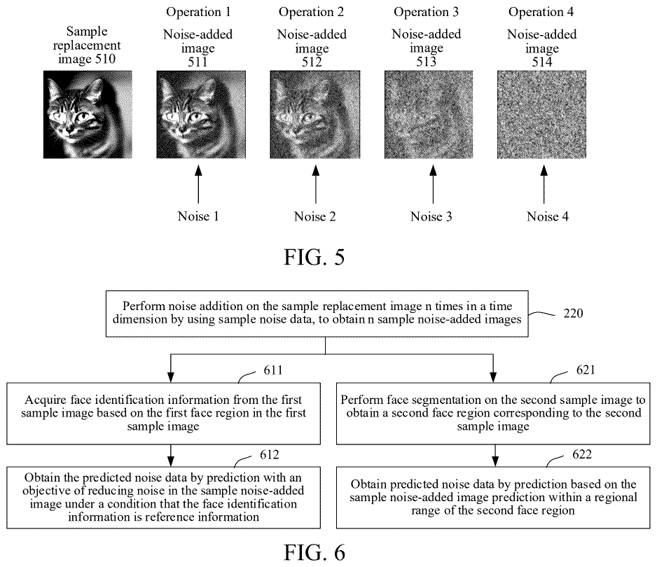

In some embodiments, FIG. 5 is a schematic diagram of noise-addition processing. A noise-addition processing process is performed based on a sample replacement image 510. FIG. 5 may be implemented as a schematic diagram of performing iterative noise-addition on the sample replacement image 510 or may alternatively be implemented as a schematic diagram of performing noise addition on the sample replacement image 510 by using a preset noise-addition policy.

This embodiment is based on an example in which FIG. 5 is implemented as a schematic diagram of performing iterative noise-addition on the sample replacement image 510. In a first noise-addition processing process (operation 1), a noise-added image 511 is obtained after noise 1 is added to the sample replacement image 510. In a second noise-addition processing process (operation 2), a noise-added image 512 is obtained after noise 2 is added to the noise-added image 511. In a third noise-addition processing process (operation 3), a noise-added image 513 is obtained after noise 3 is added to the noise-added image 512. In a fourth noise-addition processing process (operation 4), a noise-added image 514 is obtained after noise 4 is added to the noise-added image 513. If the noise-added image 514 is an image obtained after the last noise-addition processing, the noise-added image 514 is the sample noise-added image.

The foregoing four noise-addition processing processes are merely illustrative examples, and a quantity of times of noise-addition processing may be randomly set or preset, which is not limited herein.

Operation 330: Acquire facial keypoint information in the first sample image in a process of performing facial region replacement on the first sample image and the second sample image by using the facial image replacement model.

In this embodiment, the UNet in the stable diffusion model is retained in the facial image replacement model, to implement, by using UNet, a reverse denoising process represented by the stable diffusion model.

In this embodiment, the facial image replacement model is trained at least once by using the sample noise-added image. For example, by using n processing situations represented by n noise addition processes, the facial image replacement model is trained n times by using the sample noise-added image, to implement a process of performing iterative training on the facial image replacement model n times under one sample noise-added image.

In this embodiment, input of the facial image replacement model includes the first sample image, the second sample image, and the sample noise-added image. While denoising the sample noise-added image based on the first sample image and the second sample image, the facial image replacement model learns information in a process of performing facial replacement on the first sample image and the second sample image.

In this embodiment, the facial image replacement model analyzes the first sample image and acquires facial keypoint information in the first sample image.

The facial keypoint information includes a plurality of facial keypoints, and the facial keypoint information is configured for describing keypoints of facial features in the first facial region.

In this embodiment, after the first sample image is acquired, facial keypoints corresponding to the first facial region are identified by using the facial image replacement model, to acquire facial keypoints representing facial features in the first facial region.

In this embodiment, a plurality of pieces of information such as a shape, a color, and a thickness of the facial features can be acquired by using the plurality of facial keypoints. Schematically, information such as a shape, a color, and a position of a lip relative to the first facial region can be approximately determined by using a plurality of lip keypoints in the plurality of facial keypoints. Alternatively, information such as a shape, a height, and a position of a nose relative to the first facial region can be approximately determined by using a plurality of nose keypoints in the plurality of facial keypoints.

Operation 340: Acquire global image information in the second sample image.

The global image information includes at least one of image angle information, image background information, and facial expression information.

In this embodiment, the image angle information is configured for representing an orientation, such as a positive orientation or a side orientation, of a facial in the second facial region in the second sample image. The image background information is configured for representing a background region other than the second facial region in the second sample image. The facial expression information is configured for representing an expression, such as happiness, anger, sadness, or joy, of the facial in the second facial region in the second sample image.

In some embodiments, the second sample image is analyzed by using the facial image replacement model, to obtain the global image information corresponding to the second sample image.

In this embodiment, an image background of the second sample image is analyzed by using the facial image replacement model, to obtain the image background information corresponding to the second sample image. A facial angle of the second sample image is analyzed by using the facial image replacement model, to obtain the image angle information corresponding to the second sample image. A facial expression of the second sample image is analyzed by using the facial image replacement model, to obtain the facial expression information corresponding to the second sample image.

Operation 350: Obtain the predicted noise data by prediction based on at least one of the facial keypoint information and the global image information and the sample noise-added image.

In this embodiment, the predicted noise data is obtained by prediction based on the facial keypoint information and the sample noise-added image. Alternatively, the predicted noise data is obtained by prediction based on the global image information and the sample noise-added image. Alternatively, the predicted noise data is obtained by prediction based on the facial keypoint information, the global image information, and the sample noise-added image.

In this embodiment, at least one of the facial keypoint information and the global image information is taken as image guidance information.

In this embodiment, an objective of determining the facial keypoint information and the global image information is to: determine, by using the image replacement relationship between the first sample image and the second sample image, roles of the facial keypoint information and the global image information during synthesis of the facial replacement image.

For example, the facial keypoint information is configured for determining a situation of facial features representing the first facial region during synthesis of the facial replacement image. The global image information is configured for determining a background situation, an expression situation, a facial angle situation, and the like in the second sample image during synthesis of the facial replacement image.

In this embodiment, in the process of performing facial region replacement on the first sample image and the second sample image by using the facial image replacement model, facial keypoint information is taken as the image guidance information, or the global image information is taken as the image guidance information, or the facial keypoint information and the global image information are taken as the image guidance information.

The image guidance information is configured for determining a noise prediction situation when the sample noise-added image is denoised.

In this embodiment, the facial keypoints corresponding to the first sample image and the global image information corresponding to the second sample image are taken as the image guidance information, so that the facial image replacement model predicts, as accurately as possible, noise that helps to more fully display the image guidance information.

In this embodiment, the predicted noise data is obtained by prediction with an objective of reducing noise in the sample noise-added image under a condition that the image guidance information is reference information.

In this embodiment, after at least one type of information is selected as the image guidance information, the image guidance information is taken as the reference information. The reference information is taken as a reference basis for reducing noise in the sample noise-added image while the first sample image and the second sample image are learned.

In this embodiment, after the image guidance information is determined, the sample noise-added image approaches the image guidance information, so as to enable an image obtained by denoising the sample noise-added image to better display the image guidance information (the facial keypoint information and/or the global image information) than the sample noise-added image, and noise that is predicted in the approaching process and needs to denoise the sample noise-added image is referred to as predicted noise data. The predicted noise data is predicted noise data determined for the sample noise-added image under a condition that the image guidance information is reference information.

Operation 360: Train the facial image replacement model by using a difference between the sample noise data and the predicted noise data, to obtain a trained facial image replacement model.

In this embodiment, after the sample noise data and the predicted noise data are obtained, the difference between the sample noise data and the predicted noise data is determined, to obtain a noise loss value; and the facial image replacement model is trained by using the noise loss value until the trained facial image replacement model is obtained.

The trained facial image replacement model is configured to swap a second image with a facial region in a first image.

In some embodiments, random noise data is acquired; the random noise data, the first image, and the second image are inputted to the trained facial image replacement model; the trained facial image replacement model analyzes, based on the random noise data, facial keypoint information corresponding to the first image and/or global image information corresponding to the second image; and the random noise data is denoised multiple times by using the image replacement relationship between the first image and the second image and by using the facial keypoint information corresponding to the first image and/or the global image information corresponding to the first image as guidance information, so as to swap the facial region in the first image with the second image, to obtain the facial replacement image.

The foregoing is merely an illustrative example. This is not limited in this embodiment of the present disclosure.

In this embodiment of the present disclosure, the trained facial image replacement model is obtained by training from two perspectives: denoising and facial replacement, and has stronger robustness and prediction accuracy, so that a facial replacement image whose facial replacement effect is less affected by interference can be obtained. By using the facial keypoint information corresponding to the first image and/or the global image information corresponding to the second image as guidance information, accuracy of obtaining, by the facial image replacement model, the sample replacement image by restoration by using the sample noise-added image is improved as much as possible. In addition, the predicted noise data during the denoising is analyzed, which can prevent noise interference in the facial replacement process between the first image and the second image and can also focus on more essential information (information represented by the image replacement relationship) when the first image and the second image have relatively low sharpness, so that the facial replacement image has relatively strong stability.

In this embodiment, when the predicted noise data is obtained by using the facial image replacement model, facial identification analysis may also be performed on the first sample image and facial region analysis may be performed on the second sample image, to acquire the predicted noise data more precisely under a certain condition. As shown in FIG. 6, when facial identification analysis is performed on the first sample image to acquire the predicted noise data, operation 230 shown in FIG. 2 above may be implemented as the following operation 611 to operation 612. When facial region analysis is performed on the second sample image to acquire the predicted noise data, operation 230 shown in FIG. 2 above may be implemented as the following operation 621 to operation 622.

Operation 611. Acquire facial identification information from the first sample image based on the first facial region in the first sample image.

The facial identification information is configured for representing identity information represented by the first facial region. The following embodiment describes how to acquire the facial identification information.

In this embodiment, the first sample image is inputted to an identification recognition network to obtain a first identification feature representation.

The identification recognition network is a pre-trained neural network.

In this embodiment, the identification recognition network includes at least one of the following pre-trained models: an additive angular margin loss for deep facial recognition (ArcFacial) model configured for deep facial recognition, a large margin cosine loss for deep facial recognition (CosFacial) model, a deep hypersphere embedding for facial recognition (SphereFacial), and the like.

In this embodiment, the first sample image is inputted in the above identification recognition network to obtain a first identification feature representation representing identity information of the first facial region. For example, by using net Arc in FIG. 8, a first identification feature representation corresponding to the first sample image, for example, an ID feature of 1*512 dimensions, is obtained.

In this embodiment, non-linear mapping is performed on the first identification feature representation by using a transformer network, to obtain an encoded feature representation. For example, multi-layer non-linear mapping is performed on the first identification feature representation by using a 5-layer transformer network. The encoded feature representation is more related to the facial replacement process.

In this embodiment, the encoded feature representation is presented in a matrix form, and a quantity of first sample images inputted to the identification recognition network is at least one. If a plurality of first sample images are inputted into the identification recognition network, for example, 1 group (batch) includes 20 first sample images, one dimension may be added to the matrix form. Different columns in the dimension represent different first sample images.

In this embodiment, the encoded feature representation passes through a normalization (layerNorm) layer, to normalize the encoded feature representation in a feature dimension, to obtain a normalized feature representation. When the encoded feature representation in a matrix form is normalized by using the layerNorm, different feature values of the first sample image are processed. When a plurality of first sample images are included, different feature values of each first sample image are processed by taking a column as an analysis object.

For example, an encoded feature representation corresponding to any first sample image x is analyzed. A feature value corresponding to the first sample image x in the encoded feature representation is determined, and a mean value E[X] and variance Var[x] are respectively calculated based on a plurality of feature values corresponding to the first sample image x. Further, a normalized feature representation obtained after the encoded feature representation is normalized is obtained, as shown in the following formula (2):

$$y = \frac{x - E [ X ]}{\sqrt{Var [ x ] + ϵ}} * γ + β \qquad ( 2 )$$

where γ and β are an additionally learned parameter; and e is a small parameter ensuring that the variance Var[x] is not 0.

In this embodiment, the normalized feature representation passes through a fully connected layer, to obtain a second identification feature representation corresponding to the first sample image, and the second identification feature representation is taken as facial identification information corresponding to the first sample image.

In this embodiment, the facial identification information is implemented as a second identification feature representation represented in a matrix form.

Operation 612: Obtain the predicted noise data by prediction with an objective of reducing noise in the sample noise-added image under a condition that the facial identification information is reference information.

In this embodiment, after the facial identification information is determined, the sample noise-added image approaches the facial identification information, so as to enable an image obtained by denoising the sample noise-added image to better display the facial identification information than the sample noise-added image, and noise that is predicted in the approaching process and needs to denoise the sample noise-added image is referred to as predicted noise data. The predicted noise data is predicted noise data determined for the sample noise-added image under a condition that the facial identification information is guidance information.

In this embodiment, the facial identification information is implemented as the above image guidance information, and the image guidance information is configured for determining a noise prediction situation when the sample noise-added image is denoised.

In this embodiment, the facial keypoint information corresponding to the first sample image, the global image information corresponding to the second sample image, and the facial identification information are taken as the image guidance information to make the sample noise-added image approach the image guidance information, so as to enable an image obtained after the sample noise-added image is denoised to better display the image guidance information than the sample noise-added image, so that the facial image replacement model predicts, as accurately as possible, noise that can more fully display the image guidance information.

By using the process of acquiring the facial identification information described in operation 611 to operation 612, facial replacement can be performed while accuracy of the identity information is ensured.

Operation 621: Perform facial segmentation on the second sample image to obtain a second facial region corresponding to the second sample image.

In this embodiment, facial segmentation is performed on the second sample image by using a pre-trained image segmentation model, so as to obtain the second facial region corresponding to the second sample image.

The image segmentation model may be a high-resolution network (HRNet), and is configured to determine the second facial region in the second sample image.

Operation 622: Obtain predicted noise data by prediction based on the sample noise-added image prediction within a regional range of the second facial region.

In this embodiment, after the second facial region is determined, the facial replacement image is generated by using the first sample image and the second sample image with the regional range of the second facial region as a boundary.

In this embodiment, by taking the facial keypoint information corresponding to the first sample image and the global image information corresponding to the second sample image as the image guidance information, the facial replacement process is performed within the boundary of the second facial region to make the sample noise-added image approach the image guidance information, so as to enable an image obtained after the sample noise-added image is denoised to better display the image guidance information than the sample noise-added image, so that the facial image replacement model can predict, as accurately as possible, noise that can more fully display the image guidance information, and a facial region in the generated facial replacement image can be limited to the second facial region, thereby improving accuracy of generation of the facial replacement image.

In this embodiment, the facial identification information is implemented as the above image guidance information, and by taking the facial keypoint information corresponding to the first sample image, the global image information corresponding to the second sample image, and the facial identification information as the image guidance information, the facial replacement process is performed within the boundary of the second facial region to make the sample noise-added image approach the image guidance information, so as to enable an image obtained after the sample noise-added image is denoised to better display the image guidance information than the sample noise-added image, and a facial region in the generated facial replacement image can be limited to the second facial region, so that the facial image replacement model predicts, as accurately as possible, noise that can more fully display the image guidance information, that is, predicted noise data.

By using the process of determining the second facial region described in operation 621 to operation 622, facial replacement can be performed while region standardability is improved.

Operation 611 to operation 612 and operation 621 to operation 622 may be implemented in a sequential relationship (for example, operation 611 to operation 612 are first performed, and then operation 621 to operation 622 are performed; or operation 621 to operation 622 may be performed first, and then operation 611 to operation 612 may be performed); or may be implemented in a parallel relationship (for example, operation 611 to operation 612 are performed; or operation 621 to operation 622 are performed), or the like, which is not limited in this embodiment of the present disclosure.

In this embodiment of the present disclosure, the first sample image and the second sample image are analyzed, the facial identification information corresponding to the first sample image and/or the global image information corresponding to the second sample image are/is taken as the image guidance information, and when facial replacement is performed on the first sample image and the second sample image by using the facial image replacement model, the first sample image and the second sample image are analyzed more comprehensively, thereby facilitating the facial image replacement model to learn richer image information, to improve accuracy of acquisition of the predicted noise data by the facial image replacement model.

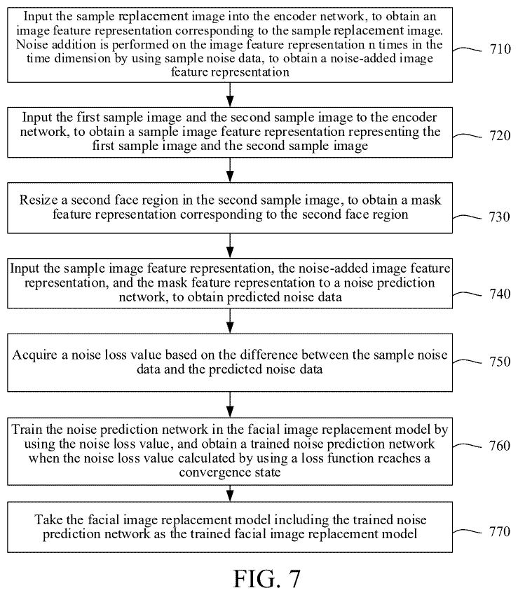

In this embodiment, the facial image replacement model includes an encoder network, a noise prediction network, and a decoder network. The encoder network is configured to extract deep feature representation of the first sample image, the second sample image, and the sample noise-added image. For example, the predicted noise data is obtained by using the sample noise-added image at a current moment. As shown in FIG. 7, operation 230 shown in FIG. 2 above may alternatively be implemented as the following operation 710 to operation 740. Operation 240 shown in FIG. 2 above may alternatively be implemented as the following operation 750 to operation 770.

Operation 710: Input the sample replacement image into the encoder network, to obtain an image feature representation corresponding to the sample replacement image. Noise addition is performed on the image feature representation n times in the time dimension by using sample noise data, to obtain a noise-added image feature representation.

In this embodiment, after the sample replacement image corresponding to the first sample image and the second sample image is obtained, the sample replacement image is inputted into the encoder network, and the encoder network performs feature extraction on the sample replacement image, to obtain the image feature representation corresponding to the sample replacement image. Noise addition is performed on the image feature representation n times in the time dimension by using sample noise data, and an n^{th} noise-added image feature representation is taken as the noise-added image feature representation.

Operation 720: Input the first sample image and the second sample image to the encoder network, to obtain a sample image feature representation representing the first sample image and the second sample image.

The sample image feature representation is a feature matrix obtained by combining a first sample feature representation corresponding to the first sample image with a second sample feature representation corresponding to the second sample image by using a concat function. The first sample feature representation and the second sample feature representation may be connected by using the concat function, but the two sample feature representation may not be changed.

FIG. 8 is a schematic diagram of a model structure of a facial image replacement model. When model training is performed on the facial image replacement model, the facial image replacement process is implemented by using the first sample image, the second sample image, and the sample replacement image.

In this embodiment, a sample replacement image 830 (not shown, represented by yt) is inputted to the encoder network of the facial image replacement model, to obtain a noise-added image feature representation corresponding to a sample noise-added image obtained by performing noise-addition processing on the sample replacement image 830 n times.

In this embodiment, a first sample image 810 and a second sample image 820 are inputted to the facial image replacement model. In this embodiment, image dimensions of the first sample image 810, the second sample image 820, and the sample replacement image 830 are cropped to 512*512. Considering that the first sample image 810, the second sample image 820, and the sample replacement image 830 are color (three-channel) images, each image is represented by 3*512*512. 6*512*512 is configured for representing a sample image feature representation obtained by combining 3*512*512 of the first sample image 810 and 3*512*512 of the second sample image 820 by using the concat function. “6” may be understood as connecting two three-channel images. scr is an abbreviation of source represented by the first sample image 810. tar is an abbreviation of target represented by the second sample image 820. yt is configured for representing the sample replacement image 830.

Deep feature extraction is performed, by using the encoder network in the facial image replacement model, on a sample noise-added image obtained after noise addition on the first sample image 810, the second sample image 820, and the sample replacement image 830.

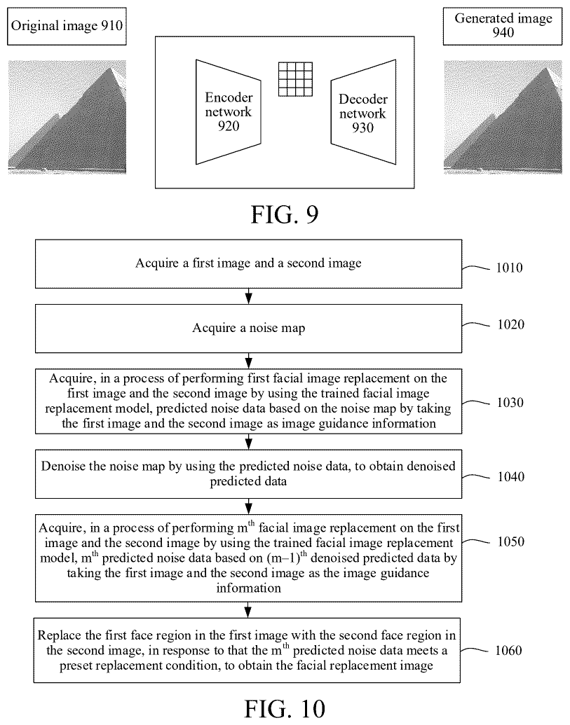

FIG. 9 is a schematic diagram of a framework structure of an encoder network-a decoder network. After an original image 910 is inputted to an encoder network 920 (an image encoder network), the encoder network 920 compresses the original image with high resolution, and finally converts the original image into a low-dimensional latent feature representation. A data dimension in which the latent feature representation is located may be described as a latent space. The latent feature representation is a low-dimensional feature representation obtained after processing by the encoder network. Subsequently, the low-dimensional feature representation is inputted to a decoder network 930, and is restored to a high-resolution generated image 940.

In the facial image replacement model shown in FIG. 8, the encoder network and the decoder network are symmetrically disposed. The following embodiment describes a network structure between the encoder network and the decoder network in FIG. 8.

As shown in FIG. 8, after deep feature extraction is performed on the first sample image 810 and the second sample image 820 by using the encoder network, a sample image feature representation representing the first sample image and the second sample image, that is, 8*64*64, is obtained. The sample image feature representation is a feature matrix obtained by combining a first sample feature representation corresponding to the first sample image with a second sample feature representation corresponding to the second sample image by using the concat function. That is, the sample image feature representation 8*64*64 is a feature matrix obtained by combining the first sample feature representation 4*64*64 with the second sample feature representation 4*64*64 by using the concat function. To reduce memory consumption and computational complexity, the UNet shown in FIG. 8 performs calculation in a low dimension of the latent space. The latent space is a low-dimensional space configured for representing data in machine learning. The latent space refers to a compressed representation of all useful information included in the data. The latent space may be generated by using various methods, such as principal component analysis (PCA) and a deep neural network (DNN). PCA is a linear dimensionality reduction method, which generates the latent space by searching for a linear combination of original data. DNN is a nonlinear dimensionality reduction method, which generates the latent space by using a nonlinear relationship in learning data. Therefore, a quantity of dimensions of the latent space is lower than that of an original data space. For example, the first sample image 810 and the second sample image 820 are both three-channel images with 512*512 pixels, which are respectively represented by 3*512*512, and are respectively represented by 4*64*64 in the latent space after being compressed by the encoder layer, thereby obtaining a sample image feature representation 8*64*64 representing the first sample image and the second sample image.

In addition, after deep feature extraction is performed, by using the encoder network, on the sample noise-added image after noise addition on the sample replacement image 830, a noise-added image feature representation representing the sample noise-added image, that is, 4*64*64, is obtained.

In some embodiments, FIG. 8 shows a pre-trained facial replacement network 800. The pre-trained facial replacement network 800 is configured to obtain a sample replacement image based on the first sample image 810 and the second sample image 820.

In this embodiment, facial replacement is performed on the first sample image 810 and the second sample image 820 by using the pre-trained facial replacement network 800, to obtain the sample replacement image. Then, noise addition is performed on the sample replacement image n times in the time dimension to obtain a sample noise-added image, where n is a positive integer.

Operation 730: Resize a second facial region in the second sample image, to obtain a mask feature representation corresponding to the second facial region.

In this embodiment, the second sample image 820 is inputted to a pre-trained image segmentation network (that is, the foregoing image segmentation model, not shown in FIG. 8), to obtain a second facial region (mask) corresponding to a facial. The mask is configured for representing a region where facial replacement is required.

In this embodiment, the mask is resized to obtain an image whose dimension is 64*64, which is represented by 1*64*64. 1*64*64 is referred to as a mask feature representation, and 1 represents a single channel.

Operation 740: Input the sample image feature representation, the noise-added image feature representation, and the mask feature representation to a noise prediction network, to obtain predicted noise data.

As shown in FIG. 8, a sample image feature representation 8*64*64, a noise-added image feature representation 4*64*64, and a mask feature representation 1*64*64 are inputted to a noise prediction network, to perform noise prediction by using the sample image feature representation 8*64*64, the mask feature representation 1*64*64, and the noise-added image feature representation 4*64*64.

In this embodiment, the sample image feature representation 8*64*64 and the mask feature representation 1*64*64 are taken as image guidance information to make the noise-added image feature representation 4*64*64 approach the image guidance information, to obtain the predicted noise data by prediction. The image guidance information is reference information inputted to the UNet.

In this embodiment, the sample image feature representation and the mask feature representation are taken as the image guidance information, a first feature distance between the noise-added image feature representation and the sample image feature representation is determined, and a second feature distance between the noise-added image feature representation and the mask feature representation is determined. A feature distance refers to a distance between feature vectors represented by two image feature representations.

In this embodiment, the sample image feature representation and the mask feature representation are taken as the image guidance information to make the noise-added image feature representation approach the mask feature representation while making the noise-added image feature representation approach the sample image feature representation as close as possible. In this embodiment, the first feature distance between the noise-added image feature representation and the sample image feature representation and the second feature distance between the noise-added image feature representation and the mask feature representation are determined in a vector space.

In some embodiments, the predicted noise data is obtained with an objective of reducing the first feature distance to a first preset threshold and the second feature distance to a second preset threshold.

In this embodiment, the second feature distance is reduced while the first feature distance is reduced, so as to obtain the predicted noise data by prediction. Alternatively, a sum of the first feature distance and the second feature distance is determined, to obtain the predicted noise data by prediction with an objective of reducing the sum of the first feature distance and the second feature distance to a preset threshold.

In this embodiment, the facial image replacement model further includes an identification acquisition layer; and identification analysis is performed on the first sample image by using the identification acquisition layer, to obtain an image identification feature representation corresponding to the first sample image.

As shown in FIG. 8, the facial image replacement model further includes an identification acquisition layer. The identification acquisition layer is configured to analyze an identity of the first sample image 810.

In this embodiment, the identification acquisition layer performs an IDentity (ID) analysis process by using a pre-trained ArcFacial model. Therefore, the identification acquisition layer is represented by ID ArcFacial in FIG. 8. When the image identification feature representation corresponding to the first sample image is acquired by using the ID ArcFacial, the following four operations are included.
(1) An ID feature (first identification feature representation) of 1*512 dimensions is obtained by using a pre-trained identification recognition network (net Arc).
(2) Multi-layer non-linear mapping is performed on the ID feature by using a mapper (5-layer transformer network), to obtain an encoded feature representation. The encoded feature representation is more related to the facial replacement process.
(3) The encoded feature representation is normalized in the feature dimension by using the layerNorm layer, to obtain a normalized feature representation.
(4) Given that the image identification feature representation needs to be analyzed by using the noise prediction network and a condition module of the noise prediction network requires an input size of the feature representation to be 768, which corresponds to a 768-dimensional vector, the normalized feature representation may be mapped to 768 dimensions, that is, Proj_out to 768 dimensions, by using the fully connected layer, so that the second identification feature representation corresponding to the first sample image is represented by 1*1*768. “1*1” denotes a padding dimension.

The second identification feature representation is configured for representing facial identification information of the first sample image. For example, the second identification feature representation is a feature representation determined based on situations such as facial feature distribution and a facial width, and is configured for more accurately confirming an identity of a person presented in the first sample image. For different images of a same person, values of the 768 dimensions of the second identification feature representation are the same or basically the same. For images of different persons, values of the 768 dimensions of the second identification feature representation thereof are clearly different. Therefore, the second identification feature representation may be taken as the facial identification information corresponding to the first sample image to represent first facial region identity information. The first sample feature representation corresponding to the first sample image is configured for representing overall image information of the first sample image, including identity information of a person presented in the first sample image and also including background information such as a building and a location presented in the first sample image.

In this embodiment, the noise prediction network uses the UNet in stable diffusion, and inputs the image identification feature representation 1*1*768 to the UNet as a condition of the UNet. The condition herein may also be understood as input data of the UNet.

In this embodiment, the image identification feature representation, the sample image feature representation, the noise-added image feature representation, and the mask feature representation are inputted to the noise prediction network, to obtain the predicted noise data.

In this embodiment, the second identification feature representation 1*1*768, the sample image feature representation 8*64*64, and the mask feature representation 1*64*64 are taken as image guidance information to make the noise-added image feature representation 4*64*64 approach the image guidance information, to obtain the predicted noise data by prediction.

In this embodiment, the sample image feature representation, the mask feature representation, and the second identification feature representation are taken as the image guidance information, a first feature distance between the noise-added image feature representation and the sample image feature representation is determined, a second feature distance between the noise-added image feature representation and the mask feature representation is determined, and a third feature distance between the noise-added image feature representation and the second identification feature representation is determined.

In this embodiment, the sample image feature representation and the mask feature representation are taken as the image guidance information to achieve approximation between the noise-added image feature representation and the mask feature representation and approximation between the noise-added image feature representation and the second identification feature representation while maximizing approximation between the noise-added image feature representation and the sample image feature representation.

In some embodiments, the predicted noise data is obtained with an objective of reducing the first feature distance to a first preset threshold, the second feature distance to a second preset threshold, and the third feature distance to a third preset threshold.

In this embodiment, the second feature distance and the third feature distance are reduced while the first feature distance is reduced, so as to obtain the predicted noise data by prediction. Alternatively, a sum of the first feature distance, the second feature distance, and the third feature distance is determined, to obtain the predicted noise data by prediction with an objective of reducing the sum of the first feature distance, the second feature distance, and the third feature distance to a preset threshold.

The foregoing is merely an illustrative example. This is not limited in the embodiments of the present disclosure.

Operation 750: Acquire a noise loss value based on the difference between the sample noise data and the predicted noise data.

In this embodiment, predicted noise data and sample noise data that is obtained when noise-addition processing is performed on the sample replacement image are acquired, and a difference between the sample noise data and the predicted noise data is determined as a noise loss value.

In some embodiments, the sample image feature representation, the noise-added image feature representation, and the mask feature representation are inputted to the noise prediction network, to obtain n pieces of predicted noise data, the n pieces of predicted noise data are in one-to-one correspondence to n noise addition processes, each of the n noise addition processes corresponds to one piece of sample noise data, the n noise addition processes correspond to n pieces of sample noise data, and the n pieces of predicted noise data are in one-to-one correspondence to the n pieces of sample noise data.

In this embodiment, when the n pieces of sample noise data are the same, in a process of performing n iterations of noise addition on the sample replacement image, a noise value of the sample noise data used in each noise addition is the same. n noise loss values are obtained based on differences between the n pieces of predicted noise data and the sample noise data.

In this embodiment, when the n pieces of sample noise data are different, in the process of performing n iterations of noise addition on the sample replacement image, a noise value of the sample noise data used in each noise addition may be different. A corresponding relationship of one-to-one correspondence between the n pieces of predicted noise data and the n pieces of sample noise data is determined, a difference between the predicted noise data and the sample noise data having a corresponding relationship therewith is determined based on the corresponding relationship, so as to obtain a noise loss value, and the n noise loss values are determined.

In some embodiments, when the n pieces of sample noise data are different, the n pieces of sample noise data may alternatively be determined by using a noise difference relationship between the n noise-added images. Schematically, first sample noise data is determined based on the sample replacement image and a first noise-added image; an i^{th} piece of sample noise-added data is determined based on an i^{th} noise-added image and an i+1^{th} noise-added; and an n^{th} piece of sample noise-added data is determined based on an n−1^{th} noise-added image and an n^{th} noise-added image, where i is a positive integer no greater than n.

The following formula (3) shows a loss function calculation formula of a noise loss value.

$$L = {E}_{t , y 0 , ε} {‖ εθ ( {y}_{t} , Xsrc , Xtar , Xmask , c , t ) - ε ‖}^{2} \qquad ( 3 )$$

where L is configured for representing a noise loss value; t is configured for representing time-series information, and is considered as a facial region replacement process at any moment herein; y0 represents a sample noise-added image; ε is noise; E_{t,y0,ε} is configured for representing a mean square error obtained by calculation based on the time-series information t, the sample noise-added image y0, and the noise ε; εθ is configured for representing a noise prediction network (UNet), and εθ(yₜ, Xsrc, Xtar, Xmask, c, t) is configured for representing a noise loss value under the time-series information t predicted after the sample noise-added image yₜ, a first sample image Xsrc, a second sample image Xtar, a second facial region Xmask, an image identification feature representation c, and the time-series information t are inputted to the UNet and by taking the second facial region Xmask and the image identification feature representation c as a condition (input) and taking the first sample image Xsrc and the second sample image Xtar as image guidance information (alternatively, the second facial region Xmask, the image identification feature representation c, the first sample image Xsrc, and the second sample image Xtar may be taken as the image guidance information); and ε is configured for representing sample noise data.

The foregoing is merely an illustrative example. This is not limited in the embodiments of the present disclosure.

Operation 760: Train the noise prediction network in the facial image replacement model by using the noise loss value, and obtain a trained noise prediction network when the noise loss value calculated by using a loss function reaches a convergence state.

In this embodiment, model training is performed on the facial image replacement model n times to obtain n noise loss values; and the noise prediction network in the facial image replacement model is trained by using the n noise loss values, and a trained noise prediction network is obtained after training is completed n times.

As shown in FIG. 8, the noise prediction network UNet in the facial image replacement model is trained n times by using the sample noise-added image, to obtain a trained noise prediction network.

Operation 770: Take the facial image replacement model including the trained noise prediction network as the trained facial image replacement model.

In this embodiment, the facial image replacement model including the trained noise prediction network is taken as the trained facial image replacement model.

The foregoing is merely an illustrative example. This is not limited in the embodiments of the present disclosure.

In this embodiment of the present disclosure, a structure of the facial image replacement model is described. After deep feature extraction is performed on the first sample image and the second sample image by using the encoder network, a latent feature representation of the first sample image and the second sample image is acquired, and further, the first sample image and the second sample image are fully analyzed based on the sample image feature representation, the noise-added image feature representation, the mask feature representation, and the image identification feature representation, so that, by using the UNet in the stable diffusion model, more targeted analysis can be performed on the noise-added image feature representation by taking the sample image feature representation, the mask feature representation, and the image identification feature representation as the image guidance information (condition), and the noise prediction network is more comprehensively trained by using the predicted noise data, to obtain the trained facial image replacement model.

In this embodiment, after the trained facial image replacement model is obtained, a facial replacement process is performed on the first image and the second image by using the trained facial image replacement model, and by using an acquired noise map, a process of acquiring a more stable facial replacement image is achieved by using a denoising process of the noise map by taking the first image and the second image as guidance information. As shown in FIG. 10, after operation 240 shown in FIG. 2 above, the method may further include the following operation 1010 to operation 1060.

Step 1010: Acquire a first image and a second image.

The first image is configured for swapping the second facial region of the second image with the first facial region.

In this embodiment, the first image is a source image, the second image is a target image, a facial replacement image is generated by using the first image and the second image, and in the facial replacement image, facial feature information, identity information, and the like on the first image need to be retained as accurately as possible, and expression information, background information, angle information, and the like on the second image need to be retained as much as possible.

In this embodiment, the first image and the second image are two randomly selected images with facial regions, for example, a first image and a second image captured by an image capturing device; or a first image and a second image captured by video screenshot; or a first image and a second image captured by network downloading.

Operation 1020: Acquire a noise map.

In this embodiment, the noise map is a randomly acquired map representing noise data; or the noise map is a preset map representing noise data.

The noise map is configured for swapping the second facial region of the second image with the first facial region by denoising.

In some embodiments, an image dimension of the first image is the same as that of the second image. For example, the image dimension of the first image is the same as that of the second image by cropping.

In this embodiment, a dimension of the noise map is the same as the image dimension of the first image and the image dimension of the second image.

In this embodiment, in a process of performing facial image replacement on the first image and the second image by using the trained facial image replacement model, by taking the first image and the second image as image guidance information, the noise map is denoised to obtain the facial replacement image.

In this embodiment, a process of determining predicted noise data related to the noise map and performing denoising includes the following operation 1030 to operation 1060.

Operation 1030: Acquire, in a process of performing first facial image replacement on the first image and the second image by using the trained facial image replacement model, predicted noise data based on the noise map by taking the first image and the second image as image guidance information.

The predicted noise data is data that is obtained by prediction by using the trained facial image replacement model and represents a noise situation.

In this embodiment, the first image, the second image, and the noise map are taken as input to the facial image replacement model, and the first image and the second image are taken as image guidance information, to determine predicted noise data on how to perform more targeted denoising on the noise map.

In this embodiment, facial keypoint information in the first image and global image information in the second image are acquired, and at least one of the facial keypoint information and the global image information is taken as image guidance information to make the noise map approach the image guidance information, to obtain predicted noise data by prediction.

In this embodiment, facial identification information and facial keypoint information in the first image and global image information in the second image are acquired, and the facial identification information, the facial keypoint information, and the global image information are taken as image guidance information to make the noise map approach the image guidance information, to obtain predicted noise data by prediction.

In this embodiment, facial identification information and facial keypoint information in the first image and global image information and a second facial region in the second image are acquired, and the facial identification information, the facial keypoint information, the global image information, and the second facial region are taken as image guidance information to make the noise map approach the image guidance information, to obtain predicted noise data by prediction.

As shown in FIG. 8, a trained facial image replacement model is obtained upon completion of training of the facial image replacement model. When the trained facial image replacement model is applied, a sample image feature representation 8*64*64 and a noise-added image feature representation 4*64*64 that are outputted by the encoder network are received by using the UNet, a mask feature representation 1*64*64 after resizing and an image identification feature representation 1*1*768 that is from an identification acquisition layer ID ArcFacial are received, so as to obtain predicted noise data by prediction based on a plurality of feature representations.

Operation 1040: Denoise the noise map by using the predicted noise data, to obtain denoised predicted data.

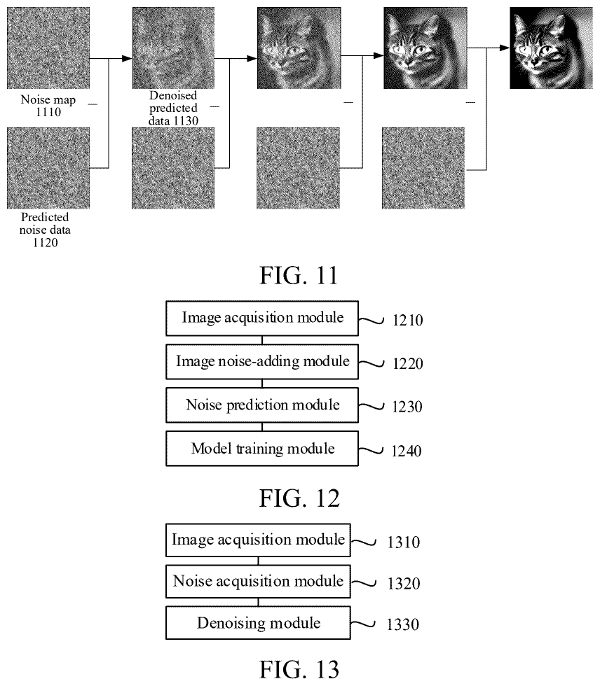

FIG. 11 is a schematic diagram of denoising. An initial stage (stage zero) includes a noise map 1110 and predicted noise data 1120. The noise map 1110 is denoised based on the predicted noise data 1120, to obtain denoised predicted data 1130 in a first stage.

Operation 1050: Acquire, in a process of performing m^{th} facial image replacement on the first image and the second image by using the trained facial image replacement model, m^{th} predicted noise data based on m−1^{th} denoised predicted data by taking the first image and the second image as the image guidance information.

m is a positive integer greater than 1.

In this embodiment, after the predicted noise data and the denoised predicted data that are obtained after the first facial replacement process are obtained, the denoised predicted data obtained after the first facial replacement process is referred to as first denoised predicted data, and the first denoised predicted data is taken as input to the second facial image replacement process, that is, the second facial image replacement process is performed based on the first denoised predicted data, the first image, and the second image. In this way, by taking the first image and the second image as image guidance information, predicted noise data after the second facial replacement process acquired based on the first denoised predicted data is referred to as second predicted noise data.

The noise map is denoised by using the second predicted noise data, to obtain the second denoised predicted data.

In this embodiment, after the second predicted noise data and the second denoised predicted data are obtained, the second denoised predicted data is taken as input to the third facial image replacement process, that is, the second facial image replacement process is performed based on the second denoised predicted data, the first image, and the second image. In this way, by taking the first image and the second image as image guidance information, predicted noise data after the third facial replacement process acquired based on the second denoised predicted data is referred to as third predicted noise data.

Operation 1060: Replace the first facial region in the first image with the second facial region in the second image, in response to that the m^{th} predicted noise data meets a preset replacement condition, to obtain the facial replacement image.

In this embodiment, the preset replacement condition is a preset replacement condition. For example, the preset replacement condition is a preset quantity of times. For example, the preset quantity of times is 50. After the predicted noise data is obtained 50 times, a facial replacement image after the second facial region in the second image is used to replace the first facial region is obtained.

That is, the foregoing process of denoising the noise map based on the first image and the second image is an iterative process, and the iterative process may be further briefly described as the following operations.
(1) A first image Xsrc and a second image Xtar whose dimensions are 512*512 are inputted to the encoder in the trained facial image replacement model, to obtain an image feature representation of 8*64*64.
(2) The second image Xtar is inputted to the pre-trained image segmentation network to obtain an image region mask of 64*64.
(3) The first image Xsrc is inputted to the IDArcFacial network in the trained facial image replacement model to obtain an identification feature representation of 1*768 dimensions.
(4) In a process of performing first facial replacement on the first image and the second image by using the trained facial image replacement model, a noise map (for example, a noise map including random noise data) is acquired, and the noise map is inputted to the encoder to obtain a denoised feature representation of 4*64*64.
(5) The denoised feature representation, the image feature representation, the image region mask, and the identification feature representation are inputted to the UNet, and by taking the image feature representation, the image region mask, and the identification feature representation as image guidance information, prediction is performed based on the denoised feature representation to obtain predicted noise data.
(6) The noise map is processed by using the predicted noise data, to obtain denoised predicted data (a prediction result Xt).
(7) In a process of performing first facial replacement on the first image and the second image by using the trained facial image replacement model after the denoised predicted data is acquired, the denoised predicted data is inputted to the encoder, to obtain a denoised feature representation of 4*64*64.
(8) The denoised feature representation, the image feature representation, the image region mask, and the identification feature representation are inputted to the UNet, and by taking the image feature representation, the image region mask, and the identification feature representation as image guidance information, prediction is performed based on the denoised feature representation to obtain predicted noise data.
(9) The denoised predicted data is processed by using the predicted noise data, to obtain next piece of denoised predicted data. Xt−1=Xt-noise, where noise is the predicted noise data.
(10) Operation 7 to operation 9 are repeated until a preset quantity of times (for example, 50, 100, or the like) is reached to obtain X0.
(11) X0 is inputted to the decoder network, to obtain a facial replacement image of 512*512.

The foregoing is merely an illustrative example. This is not limited in the embodiments of the present disclosure.

In this embodiment, the facial image replacement model includes an encoder network, a noise prediction network, and a decoder network; feature extraction is performed on the first image and the second image by using an encoder; predicted noise data is obtained based on a feature extraction result by using the decoder network, so as to obtain denoised predicted data based on the predicted noise data; and when m^{th} predicted noise data meets a preset replacement condition, the m^{th} predicted noise data is decoded by using the decoder network, so as to obtain a facial replacement image after the second facial region in the second image is used to replace the first facial region in the first image.

In this embodiment, when the foregoing method is applied to a facial replacement process in a video scenario, an image is obtained by video capturing, the image is inputted to an image segmentation model, a facial region is determined, the facial region is cropped, then a stable-diffusion-based facial replacement process is performed based on the trained facial image replacement model, and a facial replacement image is obtained and displayed.

During actual use, the trained facial image replacement model may cooperate and interact with another module. For example, first, an image input is received from a video capturing module, then facial detection is performed, a facial region is obtained by cropping, then facial replacement is performed by using the foregoing method, and display is performed.

In this embodiment of the present disclosure, the facial replacement image is restored from the noise map by denoising by using the image guidance information based on the first image and the second image, so that a problem that the facial replacement image cannot be accurately generated with high quality when the first image and the second image have relatively low image quality can be prevented. Noise interference can be prevented to a greater extent by using a denoising process of the noise map. Even in a large pose scenario and an occlusion scenario, a more stable facial replacement image can be generated by using a robustness-enhanced trained facial image replacement model. Therefore, there are a wider range of application scenarios.

FIG. 12 is a structural block diagram of a facial image replacement apparatus according to an exemplary embodiment of the present disclosure. As shown in FIG. 12, the apparatus includes the following parts:
an image acquisition module 1210, configured to acquire a first sample image, a second sample image, and a sample replacement image, the sample replacement image being an image obtained by swapping a second facial region in the second sample image with a first facial region in the first sample image;
an image noise-adding module 1220, configured to perform noise addition on the sample replacement image n times in a time dimension by using sample noise data, to obtain a sample noise-added image, n being a positive integer;
a noise prediction module 1230, configured to perform, in a process of performing facial region replacement on the first sample image and the second sample image by using a facial image replacement model, prediction based on the sample noise-added image to obtain predicted noise data, the predicted noise data being configured for restoring the sample replacement image based on the sample noise-added image; and
a model training module 1240, configured to train the facial image replacement model by using a difference between the sample noise data and the predicted noise data, to obtain a trained facial image replacement model, the trained facial image replacement model being configured to swap a second facial region in a second image with a first facial region in a first image.

In this embodiment, the noise prediction module 1230 is further configured to acquire facial keypoint information in the first sample image, the facial keypoint information including a plurality of facial keypoints, and the plurality of facial keypoints being configured for describing keypoints of facial features in the first facial region; acquire global image information in the second sample image, the global image information including at least one of image angle information, image background information, and facial expression information; and obtain the predicted noise data by prediction based on at least one of the facial keypoint information and the global image information and the sample noise-added image.

In this embodiment, the noise prediction module 1230 is further configured to use at least one of the facial keypoint information and the global image information as image guidance information, the image guidance information being configured for determining a noise prediction situation during denoising of the sample noise-added image; and obtain the predicted noise data by prediction with an objective of reducing noise in the sample noise-added image under a condition that the image guidance information is reference information.

In this embodiment, the noise prediction module 1230 is further configured to acquire facial identification information from the first sample image based on the first facial region of the first sample image, the facial identification information being configured for representing identity information represented by the first facial region; and obtain the predicted noise data by prediction with an objective of reducing noise in the sample noise-added image under a condition that the facial identification information is reference information.

In this embodiment, the noise prediction module 1230 is further configured to obtain a first identification feature representation by passing the first sample image by using an identification recognition network, the identification recognition network being a pre-trained neural network; perform non-linear mapping on the first identification feature representation by using a transformer network, to obtain an encoded feature representation; and pass the encoded feature representation through a normalization layer, to perform normalization processing on the encoded feature representation in a feature dimension to obtain a normalized feature representation; and pass the normalized feature representation through a fully connected layer, to obtain a second identification feature representation corresponding to the first sample image, and take the second identification feature representation as the facial identification information corresponding to the first sample image.

In this embodiment, the noise prediction module 1230 is further configured to perform facial segmentation on the second sample image by using a pre-trained image segmentation model, to obtain the second facial region corresponding to the second sample image; and perform prediction based on the sample noise-added image to obtain the predicted noise data in a regional range of the second facial region.

In this embodiment, the facial image replacement model includes an encoder network and a noise prediction network;
the noise prediction module 1230 is further configured to input the sample replacement image into the encoder network, to obtain an image feature representation corresponding to the sample replacement image; perform noise addition on the image feature representation n times in the time dimension by using the sample noise data, to obtain a noise-added image feature representation; and input the first sample image and the second sample image to the encoder network, to obtain a sample image feature representation representing the first sample image and the second sample image, the sample image feature representation being a feature matrix obtained by combining a first sample feature representation corresponding to the first sample image with a second sample feature representation corresponding to the second sample image by using a concat function; resize the second facial region in the second sample image, to obtain a mask feature representation corresponding to the second facial region; and input the sample image feature representation, the noise-added image feature representation, and the mask feature representation to the noise prediction network, to obtain the predicted noise data.

In this embodiment, the facial image replacement model further includes an identification acquisition layer; and
the noise prediction module 1230 is further configured to perform identification analysis on the first sample image by using the identification acquisition layer, to obtain a second identification feature representation corresponding to the first sample image; and input the second identification feature representation, the sample image feature representation, the noise-added image feature representation, and the mask feature representation to the noise prediction network, to obtain the predicted noise data.

In this embodiment, the image noise-adding module 1220 is further configured to perform n iterations of noise addition on the sample replacement image in the time dimension, to obtain the n noise-added images distributed in time series, where an n^{th} noise-added image is the sample noise-added image.

In this embodiment, the image noise-adding module 1220 is further configured to select n moments in the time dimension according to time-series distribution; perform noise-addition processing on the sample replacement image at the n moments by using a preset noise-addition policy, to obtain n noise-added images distributed in time series, where an n^{th} noise-added image is the sample noise-added image, and the preset noise-addition policy is a policy determined based on a moment parameter related to a moment and a noise parameter related to the sample noise data.

In this embodiment, the model training module 1240 is further configured to acquire a noise loss value based on the difference between the sample noise data and the predicted noise data; train the noise prediction network in the facial image replacement model by using the noise loss value, and obtain a trained noise prediction network when the noise loss value calculated by using a loss function reaches a convergence state; and take the facial image replacement model including the trained noise prediction network as the trained facial image replacement model.

FIG. 13 is a structural block diagram of a facial image replacement apparatus according to an exemplary embodiment of the present disclosure. As shown in FIG. 13, the apparatus includes the following parts:
an image acquisition module 1310, configured to acquire a first image and a second image, the first image being configured for swapping the second image with a first facial region;
a noise acquisition module 1320, configured to acquire a noise map, the noise map being a randomly acquired or preset map representing noise data, and configured to swap the second image with the first facial region by denoising; and
a denoising module 1330, configured to swap, in a process of performing facial image replacement on the first image and the second image by using a trained facial image replacement model, a second facial region of the second image with a first facial region of the first image by denoising the noise map by taking the first image and the second image as image guidance information, to obtain the facial replacement image.

In this embodiment, the denoising module 1330 is further configured to acquire, in a process of performing first facial image replacement on the first image and the second image by using the trained facial image replacement model, predicted noise data based on the noise map by taking the first image and the second image as image guidance information; denoise the noise map by using the predicted noise data, to obtain denoised predicted data; acquire, in a process of performing m^{th} facial image replacement on the first image and the second image by using the trained facial image replacement model, m^{th} predicted noise data based on m−1^{th} denoised predicted data by taking the first image and the second image as the image guidance information, where m is a positive integer greater than 1; and swap the second facial region in the second image with the first facial region in the first image in response to that the m^{th} predicted noise data meets a preset replacement condition, to obtain the facial replacement image.

The facial image replacement apparatus provided in the foregoing embodiments is merely exemplified by using division of the foregoing functional modules. In a practical application, the foregoing functions may be allocated to and completed by different functional modules as required. In other words, an internal structure of the device is divided into different functional modules, to complete all or some of the functions described above. In addition, embodiments of the facial image replacement apparatus and the facial image replacement method provided in the foregoing embodiments belong to the same conception. For a specific implementation process thereof, reference may be made to the method embodiments. Details are not described herein again.

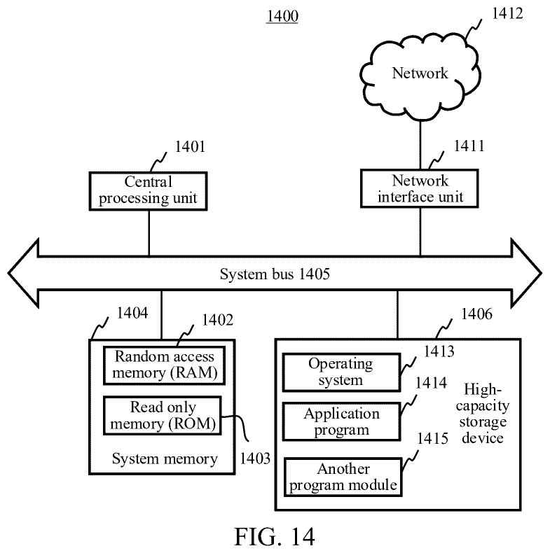

FIG. 14 is a schematic structural diagram of a server according to an exemplary embodiment of the present disclosure. The server 1400 includes a central processing unit (CPU) 1401, a system memory 1404 including a random access memory (RAM) 1402 and a read only memory (ROM) 1403, and a system bus 1405 connecting the system memory 1404 and the CPU 1401. The server 1400 further includes a high-capacity storage device 1406 configured to store an operating system 1413, an application program 1414, and another program module 1415.

The mass storage device 1406 is connected to the CPU 1401 by using a high-capacity storage controller (not shown) connected to the system bus 1405. The high-capacity storage device 1406 and a computer-readable medium associated therewith provide non-volatile storage for the server 1400. That is, the high-capacity storage device 1406 may include a computer-readable medium (not shown) such as a hard disk or a compact disc ROM (CD-ROM) drive.

In this embodiment, the computer-readable medium may include a computer storage medium and a communication medium. The computer storage medium includes volatile and non-volatile media, and removable and non-removable media implemented by using any method or technology configured for storing information such as computer-readable instructions, data structures, program modules, or other data. The system memory 1404 and the high-capacity storage device 1406 may be collectively referred to as a memory.

According to the embodiments of the present disclosure, the computer device 1400 may further be connected, by using a network such as the Internet, to a remote computer on the network and run. That is, the server 1400 may be connected to a network 1412 by using a network interfacial unit 1411 that is connected to the system bus 1405, or may be connected to a network of another type or a remote computer system (not shown) by using the network interfacial unit 1411.

The foregoing memory further includes one or more programs. The one or more programs are stored in the memory and are configured to be executed by the CPU.

An embodiment of the present disclosure further provides a computer device. The computer device includes a processor and a memory. The memory has at least one instruction, at least one program, a code set, or an instruction set stored therein. The at least one instruction, the at least one program, the code set, or the instruction set is loaded and executed by the processor to implement the facial image replacement method provided in the foregoing method embodiments.

An embodiment of the present disclosure further provides a computer-readable storage medium. The computer-readable storage medium has at least one instruction, at least one program, a code set, or an instruction set stored therein. The at least one instruction, the at least one program, the code set, or the instruction set is loaded and executed by a processor to implement the facial image replacement method provided in the foregoing method embodiments.

The technical solutions provided in the embodiments of the present disclosure achieve at least the following beneficial effects.

When performing facial region replacement between the first sample image and the second sample image by using the facial image replacement model, the predicted noise data is obtained based on the sample noise-added image obtained after noise addition is performed on the sample replacement image n times by using the sample noise data, and then the facial image replacement model is trained by using the difference between the sample noise data and the predicted noise data. A prediction process of performing noise distribution on the sample noise-added image by using the facial image replacement model helps to enable the facial image replacement model to learn a noise relationship between sample images (the first sample image and the second sample image) and the sample noise-added image. By further incorporating reference replacement between the sample replacement image, and the first/second sample images, it is conducive to improving a process of analyzing noise by the facial image replacement model in a targeted manner. Further, an image with relatively low sharpness is adjusted in a targeted manner by using a noise prediction process, to remove noise and implement a facial replacement process, thereby preventing a problem of a relatively poor generation effect of facial replacement due to relatively low image sharpness and improving robustness of the trained facial image replacement model, which helps to apply the trained facial image replacement model to a wider range of facial replacement scenarios, such as a cloud technology, artificial intelligence, and smart traffic.

An embodiment of the present disclosure further provides a computer program product or a computer program. The computer program product or the computer program includes computer instructions. The computer instructions are stored in a computer-readable storage medium. A processor of a computer device is configured to read the computer instructions from the computer-readable storage medium. The processor executes the computer instructions, causing the computer device to perform the facial image replacement method as described in any one of the foregoing embodiments.

The foregoing descriptions are merely some embodiments of the present disclosure, and are not intended to limit the present disclosure. Any modification, equivalent replacement, improvement, and the like made within the spirit and principle of the present disclosure shall fall within the protection scope of the present disclosure.

What is claimed is:

1. A facial image replacement method, comprising:
acquiring a first sample image, a second sample image, and a sample replacement image, the sample replacement image being an image obtained by replacing a first facial region in the first sample image with a second facial region in the second sample image;
performing noise addition on the sample replacement image n times in a time dimension by using sample noise data, to obtain a sample noise-added image, n being a positive integer;
performing, in a process of performing facial region replacement on the first sample image and the second sample image by using a facial image replacement model, prediction based on the sample noise-added image to obtain predicted noise data, the predicted noise data being configured for restoring the sample replacement image based on the sample noise-added image; and
training the facial image replacement model by using a difference between the sample noise data and the predicted noise data, to obtain a trained facial image replacement model, the trained facial image replacement model being configured to replace a first facial region in a first image with a second facial region in a second image.

2. The method according to claim 1, wherein performing prediction based on the sample noise-added image to obtain the predicted noise data comprises:
acquiring facial keypoint information in the first sample image, the facial keypoint information comprising a plurality of facial keypoints, and the plurality of facial keypoints being configured for describing keypoints of facial features in the first facial region;
acquiring global image information in the second sample image, the global image information comprising at least one of image angle information, image background information, and facial expression information; and
obtaining the predicted noise data by prediction based on at least one of the facial keypoint information and the global image information and the sample noise-added image.

3. The method according to claim 2, wherein obtaining the predicted noise data by prediction based on at least one of the facial keypoint information and the global image information and the sample noise-added image comprises:
using at least one of the facial keypoint information and the global image information as image guidance information, the image guidance information being configured for determining a noise prediction situation during denoising of the sample noise-added image; and
obtaining the predicted noise data by prediction with an objective of reducing noise in the sample noise-added image under a condition that the image guidance information is reference information.

4. The method according to claim 1, wherein performing prediction based on the sample noise-added image to obtain the predicted noise data comprises:
acquiring facial identification information from the first sample image based on the first facial region of the first sample image, the facial identification information being configured for representing identity information represented by the first facial region; and
obtaining the predicted noise data by prediction with an objective of reducing noise in the sample noise-added image under a condition that the facial identification information is reference information.

5. The method according to claim 4, wherein acquiring the facial identification information from the first sample image based on the first facial region of the first sample image comprises:
obtaining a first identification feature representation by passing the first sample image by using an identification recognition network, the identification recognition network being a pre-trained neural network;
performing non-linear mapping on the first identification feature representation by using a transformer network, to obtain an encoded feature representation; and
passing the encoded feature representation through a normalization layer, to perform normalization processing on the encoded feature representation in a feature dimension to obtain a normalized feature representation; and passing the normalized feature representation through a fully connected layer, to obtain a second identification feature representation corresponding to the first sample image, and taking the second identification feature representation as the facial identification information corresponding to the first sample image.

6. The method according to claim 1, wherein performing prediction based on the sample noise-added image to obtain predicted noise data comprises:
performing facial segmentation on the second sample image by using a pre-trained image segmentation model, to obtain the second facial region corresponding to the second sample image; and
performing prediction based on the sample noise-added image to obtain the predicted noise data in a regional range of the second facial region.

7. The method according to claim 1, wherein the facial image replacement model comprises an encoder network and a noise prediction network;
performing the noise addition on the sample replacement image n times in the time dimension by using sample noise data, to obtain the sample noise-added image comprises:
inputting the sample replacement image into the encoder network, to obtain an image feature representation corresponding to the sample replacement image; and performing noise addition on the image feature representation n times in the time dimension by using the sample noise data, to obtain a noise-added image feature representation; and
performing prediction based on the sample noise-added image to obtain the predicted noise data comprises:
inputting the first sample image and the second sample image to the encoder network, to obtain a sample image feature representation representing the first sample image and the second sample image, the sample image feature representation being a feature matrix obtained by combining a first sample feature representation corresponding to the first sample image with a second sample feature representation corresponding to the second sample image by using a concat function;
resizing the second facial region in the second sample image, to obtain a mask feature representation corresponding to the second facial region; and
inputting the sample image feature representation, the noise-added image feature representation, and the mask feature representation to the noise prediction network, to obtain the predicted noise data.

8. The method according to claim 7, wherein the facial image replacement model further comprises an identification acquisition layer; and
inputting the sample image feature representation, the noise-added image feature representation, and the mask feature representation to the noise prediction network, to obtain the predicted noise data comprises:
performing identification analysis on the first sample image by using the identification acquisition layer, to obtain a second identification feature representation corresponding to the first sample image; and
inputting the second identification feature representation, the sample image feature representation, the noise-added image feature representation, and the mask feature representation to the noise prediction network, to obtain the predicted noise data.

9. The method according to claim 1, wherein performing the noise addition on the sample replacement image n times in the time dimension by using the sample noise data, to obtain the sample noise-added image comprises:
performing n iterations of noise addition on the sample replacement image in the time dimension by using the sample noise data with a same noise value, to obtain n noise-added images distributed in time series, wherein an n^{th} noise-added image is the sample noise-added image, and a noise difference between two adjacent noise-added images in the n noise-added images is the sample noise data;
or
performing n iterations of noise addition on the sample replacement image in the time dimension by using the sample noise data with different noise values, to obtain n noise-added images distributed in time series, wherein an n^{th} noise-added image is the sample noise-added image; wherein a noise difference between a v^{th} noise-added image and a v+1^{th} noise-added image is the sample noise data used during a v^{th} iteration of noise addition, and v is a positive integer no greater than n.

10. The method according to claim 1, wherein performing the noise addition on the sample replacement image n times in the time dimension by using the sample noise data, to obtain the sample noise-added image comprises:
selecting n moments in the time dimension according to time-series distribution; and
performing noise-addition processing on the sample replacement image at the n moments by using a preset noise-addition policy, to obtain n noise-added images distributed in time series, wherein an n^{th} noise-added image is the sample noise-added image, and the preset noise-addition policy is a policy determined based on a moment parameter related to a moment and a noise parameter related to the sample noise data.

11. The method according to claim 1, wherein training the facial image replacement model by using the difference between the sample noise data and the predicted noise data to obtain the trained facial image replacement model comprises:
acquiring a noise loss value based on the difference between the sample noise data and the predicted noise data;
training the noise prediction network in the facial image replacement model by using the noise loss value, and obtaining a trained noise prediction network when the noise loss value calculated by using a loss function reaches a convergence state; and
taking the facial image replacement model comprising the trained noise prediction network as the trained facial image replacement model.

12. A computer device, comprising:
one or more processors and a memory containing at least one program that, when being executed, causes the one or more processors to perform:
acquiring a first sample image, a second sample image, and a sample replacement image, the sample replacement image being an image obtained by replacing a first facial region in the first sample image with a second facial region in the second sample image;
performing noise addition on the sample replacement image n times in a time dimension by using sample noise data, to obtain a sample noise-added image, n being a positive integer;
performing, in a process of performing facial region replacement on the first sample image and the second sample image by using a facial image replacement model, prediction based on the sample noise-added image to obtain predicted noise data, the predicted noise data being configured for restoring the sample replacement image based on the sample noise-added image; and
training the facial image replacement model by using a difference between the sample noise data and the predicted noise data, to obtain a trained facial image replacement model, the trained facial image replacement model being configured to replace a first facial region in a first image with a second facial region in a second image.

13. The device according to claim 12, wherein the one or more processors are further configured to perform:
acquiring facial keypoint information in the first sample image, the facial keypoint information comprising a plurality of facial keypoints, and the plurality of facial keypoints being configured for describing keypoints of facial features in the first facial region;
acquiring global image information in the second sample image, the global image information comprising at least one of image angle information, image background information, and facial expression information; and
obtaining the predicted noise data by prediction based on at least one of the facial keypoint information and the global image information and the sample noise-added image.

14. The device according to claim 13, wherein the one or more processors are further configured to perform:
using at least one of the facial keypoint information and the global image information as image guidance information, the image guidance information being configured for determining a noise prediction situation during denoising of the sample noise-added image; and
obtaining the predicted noise data by prediction with an objective of reducing noise in the sample noise-added image under a condition that the image guidance information is reference information.

15. The device according to claim 12, wherein the one or more processors are further configured to perform:
acquiring facial identification information from the first sample image based on the first facial region of the first sample image, the facial identification information being configured for representing identity information represented by the first facial region; and
obtaining the predicted noise data by prediction with an objective of reducing noise in the sample noise-added image under a condition that the facial identification information is reference information.

16. The device according to claim 15, wherein the one or more processors are further configured to perform:
obtaining a first identification feature representation by passing the first sample image by using an identification recognition network, the identification recognition network being a pre-trained neural network;
performing non-linear mapping on the first identification feature representation by using a transformer network, to obtain an encoded feature representation; and
passing the encoded feature representation through a normalization layer, to perform normalization processing on the encoded feature representation in a feature dimension to obtain a normalized feature representation; and passing the normalized feature representation through a fully connected layer, to obtain a second identification feature representation corresponding to the first sample image, and taking the second identification feature representation as the facial identification information corresponding to the first sample image.

17. The device according to claim 12, wherein the one or more processors are further configured to perform:
performing facial segmentation on the second sample image by using a pre-trained image segmentation model, to obtain the second facial region corresponding to the second sample image; and
performing prediction based on the sample noise-added image to obtain the predicted noise data in a regional range of the second facial region.

18. The device according to claim 12, wherein the facial image replacement model comprises an encoder network and a noise prediction network; and the one or more processors are further configured to perform:
inputting the sample replacement image into the encoder network, to obtain an image feature representation corresponding to the sample replacement image; and performing noise addition on the image feature representation n times in the time dimension by using the sample noise data, to obtain a noise-added image feature representation;
inputting the first sample image and the second sample image to the encoder network, to obtain a sample image feature representation representing the first sample image and the second sample image, the sample image feature representation being a feature matrix obtained by combining a first sample feature representation corresponding to the first sample image with a second sample feature representation corresponding to the second sample image by using a concat function;
resizing the second facial region in the second sample image, to obtain a mask feature representation corresponding to the second facial region; and
inputting the sample image feature representation, the noise-added image feature representation, and the mask feature representation to the noise prediction network, to obtain the predicted noise data.

19. The device according to claim 18, wherein the facial image replacement model further comprises an identification acquisition layer; and the one or more processors are further configured to perform:
performing identification analysis on the first sample image by using the identification acquisition layer, to obtain a second identification feature representation corresponding to the first sample image; and
inputting the second identification feature representation, the sample image feature representation, the noise-added image feature representation, and the mask feature representation to the noise prediction network, to obtain the predicted noise data.

20. A non-transitory computer readable storage medium containing at least one program that, when being executed, causes at least one processor to perform:
acquiring a first sample image, a second sample image, and a sample replacement image, the sample replacement image being an image obtained by replacing a first facial region in the first sample image with a second facial region in the second sample image;
performing noise addition on the sample replacement image n times in a time dimension by using sample noise data, to obtain a sample noise-added image, n being a positive integer;
performing, in a process of performing facial region replacement on the first sample image and the second sample image by using a facial image replacement model, prediction based on the sample noise-added image to obtain predicted noise data, the predicted noise data being configured for restoring the sample replacement image based on the sample noise-added image; and
training the facial image replacement model by using a difference between the sample noise data and the predicted noise data, to obtain a trained facial image replacement model, the trained facial image replacement model being configured to replace a first facial region in a first image with a second facial region in a second image.
